(19) United States
(12) Patent Application Publication
(10) Pub. No.: US 2025/0094114 A1
(43) Pub. Date: Mar. 20, 2025

(54) SYSTEMS AND METHODS FOR GENERATING AN INTERACTIVE VIRTUAL ENVIRONMENT

(71) Applicant: Venkateshwaran RAMADOSS, Toronto (CA)

(72) Inventor: Venkateshwaran RAMADOSS, Toronto (CA)

(21) Appl. No.: 18/968,539

(22) Filed: Dec. 4, 2024

Related U.S. Application Data
(63) Continuation of application No. PCT/CA2023/050739, filed on May 30, 2023.
(60) Provisional application No. 63/350,158, filed on Jun. 8, 2022.

(51) Int. Cl. G06F 3/14; G06F 3/16; H04N 23/90

(52) U.S. Cl. CPC G06F 3/1446; G06F 3/165; H04N 23/90

(57) ABSTRACT

A system for generating an interactive virtual environment is provided. The system comprises a processor in communication with a first interaction unit and a data storage unit storing instructions executable by the processor. The first interaction unit comprises a first display device, a first video capture device, a second display device and a second video capture device. The second video capture device is operable to capture video data of the interior portion of the first interaction unit and the at least a portion of the first display device from a second perspective. The processor is configured to provide a first display signal to the first display device; receive a first video signal from the second video capture device; and provide a second display signal to a display device of a second interaction unit, the second display signal based on the first video signal.

### CROSS-REFERENCE TO RELATED APPLICATION(S)

This application is a continuation of PCT/CA2023/050739 filed on May 30, 2023, which claims priority from U.S. Provisional Patent Application No. 63/350,158 filed on Jun. 8, 2022, each of which is incorporated herein by reference in their entirety.

### FIELD

The present disclosure relates to interactive virtual environments, and in particular to systems and methods for generating an interactive virtual environment.

### BACKGROUND

The following is not an admission that anything discussed below is part of the prior art or part of the common general knowledge of a person skilled in the art.

U.S. Pat. No. 10,841,537 of Valli et al. purports to disclose systems and methods for managing user positions in a shared virtual geometry, capturing 360° views of a local user environment in a spatially faithful system, and computing a perspective view of a first user from the eye-point of a second user. Users may move around the shared virtual geometry, and perspective views of users may be updated. Some embodiments may use a co-centric geometry for group conferencing with other users. Some embodiments may use a grid-based geometry for exploration with other users. Some embodiments may reduce transferred bitrates to enable systems and methods to be implemented in data-limited environments. Some embodiments may support users moving and navigating a shared virtual geometry.

U.S. Pat. No. 10,694,147 of Bakshi purports to disclose communication schemes involving “portal” structures, “channels” and “phonos.” The portal structures may be mobile and easily deployed to the remote locations, for quick assembly and use, creating an audio-visual immersive communication experience for its users. A portal network architecture may include a plurality of portals located in different remote locations, configured to provide identical spaces that facilitate audio-video, immersive conferencing among users at the various portal sites. The portal interiors may include favorable lighting and camera configurations to facilitate display of life-size, realistic, and planar images of the users while maintaining eye contact between them. The “channels” may facilitate viewing of landscape or persons from a distance and “phonos” implementations may provide an unmediated aural link between different locations, enabling both real-time conversation and transmission of ambient sounds.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with a broad aspect, there is provided a system for generating an interactive virtual environment. The system comprises a processor in communication with a first interaction unit and a data storage unit storing instructions executable by the processor. The first interaction unit comprises a first display device; a first video capture device, wherein the first display device and the first video capture device are disposed along a first side of the interaction unit; a second display device, wherein the first video capture device is positioned facing at least a portion of the second display device and the first video capture device is operable to capture video data of an interior portion of the first interaction unit and the at least a portion of the second display device from a first perspective; and a second video capture device, wherein the second video capture device is positioned facing at least a portion of the first display device and the second video capture device is operable to capture video data of the interior portion of the first interaction unit and the at least a portion of the first display device from a second perspective. The processor is configured to provide a first display signal to the first display device, the first display signal usable to generate a first display of the interactive virtual environment on the first display device, wherein the first display comprises a first view into the interactive virtual environment from a perspective of the first display device, wherein the perspective of the first display device is defined based on a virtual location and a virtual orientation of the first interaction unit within the interactive virtual environment. The processor is further configured to receive a first video signal from the second video capture device, the first video signal comprising captured video data, from the second perspective, of the interior portion of the first interaction unit and at least a portion of the first display of the interactive virtual environment on the first display device. The processor is also configured to provide a second display signal to a display device of a second interaction unit, the second display signal based on the first video signal and usable to generate a second display of the interactive virtual environment on the display device of the second interaction unit, wherein the second display comprises a second view into the interactive virtual environment, the second view including a portion of the interior portion of the first interaction unit and the at least a portion of the first display from a perspective of the display device of the second interaction unit.

The processor can be further configured to receive a second video signal from a video capture device of the second interaction unit, the second video signal comprising video data of an interior of the second interaction unit; and provide a third display signal to the second display device, the third display signal based on the second video signal and usable to generate a third display of the interactive virtual environment on the second display device, wherein the third display comprises a third view into the interactive virtual environment, the third view including a portion of the environment of the second interaction unit from a perspective of the second display device, wherein the perspective of the second display device is defined based on the virtual location and the virtual orientation of the first interaction unit within the interactive virtual environment.

The first display signal can be based on a third video signal received from a video capture device of a third interaction unit, the third video signal comprising captured video data of the interior portion of the third interaction unit, and the first view includes a portion of the interior portion of the third interaction unit.

The first interaction unit can comprise three or more display devices and three or more video capture devices, wherein each given video capture device of the three or more video capture devices is positioned facing at least a portion of a given display device of the three or more display devices and the given video capture device is operable to capture video data of the interior portion of the first interaction unit and the at least a portion of the given display device from a given perspective of the multiple perspectives; and the processor can be further configured to provide a given display signal to each given display device of the three or more display devices, the given display signal usable to generate a given display of the interactive virtual environment on the given display device, wherein the given display comprises a given view into the interactive virtual environment from a respective perspective of the given display device, wherein each given view is determined based on the virtual location and virtual orientation of the first interaction unit within the interactive virtual environment.

The first interaction unit can further comprise a first audio playback device, and a first audio capture device positioned to capture audio data within the interior portion of the first interaction unit. The processor can be further configured to provide a first audio signal to the first audio playback device, the first audio signal usable to generate a first audio output associated with the interactive virtual environment by the first audio playback device, wherein the first audio signal includes at least portion of audio data captured by an audio capture device of the second interaction unit; and provide a second audio signal to an audio playback device of the second interaction unit, the second audio signal usable to generate a second audio output associated with the interactive virtual environment by the audio playback device of the second interaction unit, wherein the second audio signal includes at least a portion of audio data captured by the first audio capture device.

The output volume level of the first audio playback device associated with the portion of audio data captured by the audio capture device of the second interaction unit can be based on a virtual distance between the virtual location of the first interaction unit and a second virtual location of the second interaction unit in the interactive virtual environment.

The first interaction unit can be provided using a physical environment unit (PEU) comprising multiple walls and a floor configured to fully surround one or more users while the one or more users participate in the interactive virtual environment.

The PEU can be shaped as a n-sided polygonal prism or a cylindrical prism.

The n-sided polygonal prism can be one of a cubic prism, a hexagonal prism or an octagonal prism.

The first display device and the second video capture device can be positioned opposite to each other along a common optical axis.

The first interaction unit and the second interaction unit can be virtually arranged within the interactive virtual environment such that the second display device and the second video capture device are virtually disposed along a second side of the first interaction unit; and the display device of the second interaction unit is disposed along a side of the second interaction unit. The processor can be further configured to virtually position the first interaction unit and the second interaction unit adjacent to each other in the interactive virtual environment by positioning the second side of the first interaction unit and the side of the second interaction unit adjacent and substantially parallel to each other in the interactive virtual environment.

The interactive virtual environment can comprise a plurality of virtual interaction units arranged within the interactive virtual environment, the plurality of virtual interaction units including a first plurality of physical interaction units having corresponding physical interaction units capable of receiving one or more users therewithin and at least one phantom interaction unit that does not correspond to any in-use physical interaction unit.

The first interaction unit can be provided using a physical environment unit (PEU) comprising multiple walls and a floor configured to fully surround a user while the user participates in the interactive virtual environment, and the second interaction unit is provided as a physical display unit (PDU) comprising a first side and a second side arranged adjacent and substantially parallel to each other along a common optical axis, the display device and the video capture device of the second interaction unit being disposed along the first side of the PDU. The processor can be further configured to provide a fourth display signal to a second display device of the second interaction unit disposed along the second side of the PDU, the fourth display signal usable to generate a fourth display of the interactive virtual environment on the second display device of the second interaction unit, wherein the fourth display comprises a fourth view into the interactive virtual environment, the fourth view including a portion of the interior portion of the first interaction unit and the generated third display; and wherein the first display includes video data of the environment of the PDU captured by a second video capture device of the second interaction unit disposed along the second side of the PDU.

The first interaction unit can further comprise a motion simulator device operable to simulate movement aligning with movement in the interactive virtual environment.

The first interaction unit can comprise one or more additional sensors including video capture devices located external to the first interaction unit, a location sensor, an ambient light sensor, a motion sensor, a moisture sensor, a temperature sensor, an air pressure sensor, a proximity sensor, a fingerprint sensor, a facial recognition sensor or a LiDAR scanner.

The interactive virtual environment can simulate a meeting room, an office space, a party hall, a public square, or a gaming universe.

In accordance with a broad aspect, there is provided a method for generating an interactive virtual environment, the method implemented by a processor executing instructions stored on a data storage unit, the processor in communication with a first interaction unit. The first interaction unit comprises a first display device; a first video capture device, wherein the first display device and the first video capture device are disposed along a first side of the interaction unit; a second display device, wherein the first video capture device is positioned facing at least a portion of the second display device and the first video capture device is operable to capture video data of an interior portion of the first interaction unit and the at least a portion of the second display device from a first perspective; and a second video capture device, wherein the second video capture device is positioned facing at least a portion of the first display device and the second video capture device is operable to capture video data of the interior portion of the first interaction unit and the at least a portion of the first display device from a second perspective. The method comprises: providing, by the processor, a first display signal to the first display device, the first display signal usable to generate a first display of the interactive virtual environment on the first display device, wherein the first display comprises a first view into the interactive virtual environment from a perspective of the first display device, wherein the perspective of the first display device is defined based on a virtual location and a virtual orientation of the first interaction unit within the interactive virtual environment; receiving, by the processor, a first video signal from the second video capture device, the first video signal comprising captured video data, from the second perspective, of the interior portion of the first interaction unit and at least a portion of the first display of the interactive virtual environment on the first display device; and providing, by the processor, a second display signal to a display device of a second interaction unit, the second display signal based on the first video signal and usable to generate a second display of the interactive virtual environment on the display device of the second interaction unit, wherein the second display comprises a second view into the interactive virtual environment, the second view including a portion of the interior portion of the first interaction unit and the at least a portion of the first display from a perspective of the display device of the second interaction unit.

The method can further comprise: receiving, by the processor, a second video signal from a video capture device of the second interaction unit, the second video signal comprising video data of an interior of the second interaction unit; and providing, by the processor, a third display signal to the second display device, the third display signal based on the second video signal and usable to generate a third display of the interactive virtual environment on the second display device, wherein the third display comprises a third view into the interactive virtual environment, the third view including a portion of the environment of the second interaction unit from a perspective of the second display device, wherein the perspective of the second display device is defined based on the virtual location and the virtual orientation of the first interaction unit within the interactive virtual environment.

The first display signal can be based on a third video signal received from a video capture device of a third interaction unit, the third video signal comprising captured video data of the interior portion of the third interaction unit, and the first view includes a portion of the interior portion of the third interaction unit.

The first interaction unit can comprise three or more display devices and three or more video capture devices, wherein each given video capture device of the three or more video capture devices is positioned facing at least a portion of a given display device of the three or more display devices and the given video capture device is operable to capture video data of the interior portion of the first interaction unit and the at least a portion of the given display device from a given perspective of the multiple perspectives. The method can further comprise, providing, by the processor, a given display signal to each given display device of the three or more display devices, the given display signal usable to generate a given display of the interactive virtual environment on the given display device, wherein the given display comprises a given view into the interactive virtual environment from a respective perspective of the given display device, wherein each given view is determined based on the virtual location and virtual orientation of the first interaction unit within the interactive virtual environment.

The first interaction unit can further comprise a first audio playback device, and a first audio capture device positioned to capture audio data within the interior portion of the first interaction unit. The method can further comprise, providing, by the processor, a first audio signal to the first audio playback device, the first audio signal usable to generate a first audio output associated with the interactive virtual environment by the first audio playback device, wherein the first audio signal includes at least portion of audio data captured by an audio capture device of the second interaction unit; and providing, by the processor, a second audio signal to an audio playback device of the second interaction unit, the second audio signal usable to generate a second audio output associated with the interactive virtual environment by the audio playback device of the second interaction unit, wherein the second audio signal includes at least a portion of audio data captured by the first audio capture device.

The output volume level of the first audio playback device associated with the portion of audio data captured by the audio capture device of the second interaction unit can be based on a virtual distance between the virtual location of the first interaction unit and a second virtual location of the second interaction unit in the interactive virtual environment.

The first interaction unit can be provided using a physical environment unit (PEU) comprising multiple walls and a floor configured to fully surround one or more users while the one or more users participate in the interactive virtual environment.

The PEU can be shaped as a n-sided polygonal prism or a cylindrical prism.

The n-sided polygonal prism can be one of a cubic prism, a hexagonal prism or an octagonal prism.

The first display device and the second video capture device can be positioned opposite to each other along a common optical axis.

The first interaction unit and the second interaction unit can be virtually arranged within the interactive virtual environment such that the second display device and the second video capture device are virtually disposed along a second side of the first interaction unit; and the display device of the second interaction unit is disposed along a side of the second interaction unit. The method can further comprise, virtually positioning, by the processor, the first interaction unit and the second interaction unit adjacent to each other in the interactive virtual environment by positioning the second side of the first interaction unit and the side of the second interaction unit adjacent and substantially parallel to each other in the interactive virtual environment.

The interactive virtual environment can comprise a plurality of virtual interaction units arranged within the interactive virtual environment, the plurality of virtual interaction units including a first plurality of physical interaction units having corresponding physical interaction units capable of receiving one or more users therewithin and at least one phantom interaction unit that does not correspond to any in-use physical interaction unit.

The first interaction unit can be provided using a physical environment unit (PEU) comprising multiple walls and a floor configured to fully surround a user while the user participates in the interactive virtual environment, and the second interaction unit can be provided as a physical display unit (PDU) comprising a first side and a second side arranged adjacent and substantially parallel to each other along a common optical axis, the display device and the video capture device of the second interaction unit being disposed along the first side of the PDU. The method can further comprise, providing, by the processor, a fourth display signal to a second display device of the second interaction unit disposed along the second side of the PDU, the fourth display signal usable to generate a fourth display of the interactive virtual environment on the second display device of the second interaction unit, wherein the fourth display comprises a fourth view into the interactive virtual environment, the fourth view including a portion of the interior portion of the first interaction unit and the generated third display; and wherein the first display includes video data of the environment of the PDU captured by a second video capture device of the second interaction unit disposed along the second side of the PDU.

The first interaction unit can further comprise a motion simulator device operable to simulate movement aligning with movement in the interactive virtual environment.

The first interaction unit can comprise one or more additional sensors including video capture devices located external to the first interaction unit, a location sensor, an ambient light sensor, a motion sensor, a moisture sensor, a temperature sensor, an air pressure sensor, a proximity sensor, a fingerprint sensor, a facial recognition sensor or a LIDAR scanner.

The interactive virtual environment can simulate a meeting room, an office space, a party hall, a public square, or a gaming universe.

In accordance with a broad aspect, there is provided a computer program product comprising a non-transitory computer-readable medium storing computer-executable instructions for configuring a processor to perform a method for generating an interactive virtual environment, wherein the method is described herein.

In accordance with a broad aspect, there is provided a system for generating an interactive virtual environment. The system may comprise a data storage unit storing processor-executable instructions, a processor in communication with the data storage unit, a first interaction unit, and a second interaction unit. The first interaction unit may comprise: a first display device, a second display device, a first video capture device positioned facing outwardly at the first interaction unit, the first video capture device operable to capture video data of a surrounding environment of the first interaction unit from a first perspective, and a second video capture device positioned facing outwardly at the first interaction unit, the second video capture device operable to capture video data of the surrounding environment of the first interaction unit from a second perspective. The second interaction unit may comprise: a third display device, a fourth display device, a third video capture device positioned facing at least a portion of the fourth display device, the third video capture device operable to capture video data of an interior portion of the second interaction unit and the at least a portion of the fourth display device from a third perspective, and a fourth video capture device positioned facing at least a portion of the third display device, the fourth video capture device operable to capture video data of the interior portion of the second interaction unit and the at least a portion of the third display device from a fourth perspective. The processor is configured to: receive a first video signal from the first video capture device, provide a first display signal to the third display device, the first display signal based on the first video signal and usable to generate a first display of the interactive virtual environment on the third display device, wherein the first display includes at least a portion of the surrounding environment of the first interaction unit from the first perspective, receive a second video signal from the second video capture device, provide a second display signal to the fourth display device, the second display signal based on the second video signal and usable to generate a second display of the interactive virtual environment on the fourth display device, wherein the second display includes at least a portion of the surrounding environment of the first interaction unit from the second perspective, receive a third video signal from the third video capture device, the third video signal comprising captured video data, from the third perspective, of the interior portion of the second interaction unit and at least a portion of the second display of the interactive virtual environment on the fourth display device, and receive a fourth video signal from the fourth video capture device, the fourth video signal comprising captured video data, from the fourth perspective, of the interior portion of the second interaction unit and at least a portion of the first display of the interactive virtual environment on the third display device.

At least one of the first interaction unit and the second interaction unit may comprise a cylindrical prism-shaped portion.

The processor may be further configured to: provide a third display signal to the first display device, the third display signal based on the third video signal and usable to generate a third display of the interactive virtual environment on the first display device, wherein the third display includes at least a portion of the interior portion of the second interaction unit and the second display of the interactive virtual environment on the fourth display device from the third perspective.

The processor may be further configured to: provide a fourth display signal to the second display device, the fourth display signal based on the fourth video signal and usable to generate a fourth display of the interactive virtual environment on the second display device, wherein the fourth display includes at least a portion of the interior portion of the second interaction unit and the first display of the interactive virtual environment on the third display device from the fourth perspective.

The first interaction unit may further comprise a first audio playback device, and a first audio capture device positioned to capture audio data of a surrounding environment of the first interaction unit. The second interaction unit may further comprise a second audio playback device, and a second audio capture device positioned to capture audio data within the interior portion of the second interaction unit. The processor may be further configured to: provide a first audio signal to the first audio playback device, the first audio signal usable to generate a first audio output associated with the interactive virtual environment by the first audio playback device, wherein the first audio signal includes at least portion of audio data captured by the second audio capture device; and provide a second audio signal to the second audio playback device, the second audio signal usable to generate a second audio output associated with the interactive virtual environment by the second audio playback device, wherein the second audio signal includes at least a portion of audio data captured by the first audio capture device.

It will be appreciated by a person skilled in the art that a device, method or computer program product disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

The drawings included herewith are for illustrating various examples of systems, methods, and devices of the teaching of the present specification and are not intended to limit the scope of what is taught in any way.

FIG. 1 shows a block diagram of an example system for generating an interactive virtual environment.

FIG. 2A shows a schematic perspective view of an example interaction unit that may be used with the system of FIG. 1.

FIG. 2B shows a schematic view of an example interaction unit that may be used with the system of FIG. 1.

FIG. 2C shows a schematic lateral view of an example interaction unit that may be used with the system of FIG. 1.

FIG. 2D shows a schematic top view of the example interaction unit shown in FIG. 2B illustrating an example arrangement of display devices and video capture devices.

FIG. 2E shows perspective views of an example interaction unit that may be used with the system of FIG. 1.

FIG. 2F shows perspective views of an example interaction unit that may be used with the system of FIG. 1.

FIG. 3 shows a block diagram of an example control unit that may be used with the system of FIG. 1.

FIG. 4A shows an example of a virtual arrangement of interaction units that may be used with the system of FIG. 1.

FIG. 4B shows another example of a virtual arrangement of interaction units that may be used with the system of FIG. 1.

FIG. 4C shows another example of a virtual arrangement of interaction units that may be used with the system of FIG. 1.

FIG. 4D shows another example of a virtual arrangement of interaction units that may be used with the system of FIG. 1.

FIG. 4E shows an example method of virtually arranging interaction units that may be used with the system of FIG. 1.

FIG. 4F shows an example method of modifying a virtual arrangement of interaction units that may be used with the system of FIG. 1.

FIG. 5 is a flowchart showing an example method for generating an interactive virtual environment that may be used with the system of FIG. 1.

FIG. 6A is a lateral schematic view of interaction units that may be used with the system of FIG. 1.

FIG. 6B is a schematic diagram showing video data flow between interaction units in the example system shown in FIG. 6A.

FIG. 6C shows example images of captured video data that may be included in the data flow shown in FIG. 6B.

FIG. 6D is a schematic diagram showing audio data flow between interaction units in the example system shown in FIG. 6A.

FIG. 7 is a schematic diagram showing interaction units in a portion of the virtual arrangement shown in FIG. 4B.

FIG. 8A shows a schematic side view, front view and rear view of an example interaction unit that may be used with the system of FIG. 1.

FIG. 8B is a schematic diagram showing placement of the example interaction unit of FIG. 8A in a physical environment.

FIG. 8C shows a perspective view and a side view of an example interaction unit that may be used with the system of FIG. 1.

FIG. 8D shows a perspective view and a side view of an example interaction unit that may be used with the system of FIG. 1.

FIG. 9 is a schematic diagram showing an example configuration with a plurality of nested interaction units positioned within an outer interaction unit.

### DETAILED DESCRIPTION

The drawings, described below, are provided for purposes of illustration, and not of limitation, of the aspects and features of various examples described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Various systems or methods will be described below to provide an example of the claimed subject matter. No examples described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an examples that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Some elements herein may be identified by a part number, which is composed of a base number followed by an alphabetical or subscript-numerical suffix (e.g. 112a, or 1121). Multiple elements herein may be identified by part numbers that share a base number in common and that differ by their suffixes (e.g. 1121, 1122, and 1123). All elements with a common base number may be referred to collectively or generically using the base number without a suffix (e.g. 112).

The example systems and methods described herein may be implemented as a combination of hardware or software. In some cases, the examples described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the examples described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the examples described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

Computer systems and computer-implemented methods can be used to generate virtual environments. These virtual environments can represent spatial environments including recreations of real-world environments as well as artificial environments. The virtual environments may be generated wholly or in part using real-world imagery captured by video and/or image capture devices.

The virtual environments can include artificial environments or artificial environment portions generated using computer-generated imagery. Some virtual environments can include elements of both real-world environments and artificial environments. Virtual environments may be generated using a combination of real-world and computer-generated imagery. Examples of virtual environments include a meeting room, an office space, a party hall, a public square, or a gaming universe.

Interactive virtual environments can allow users to interact with components of the environment and/or other users within the virtual environment. This may allow multiple users to interact virtually within a shared virtual environment. The users may be at locations that are remote from one another while still participating in the shared virtual environment. This may allow users to interact in a more natural manner even while located remotely from one another. The interactive virtual environments can, for example, simulate a meeting between multiple users in a meeting room, an office space, a party hall, a public square, or a gaming universe.

A user may interact with an interactive virtual environment using actions, gestures, speech, and/or other I/O devices like a joystick, a touchscreen, a mouse or a keyboard. The interactive virtual environment may be updated based on the user interactions. For example, a portion of the virtual environment may be generated based on data captured from the user's physical environment as the user interacts with the virtual environment.

The present disclosure provides systems, methods and computer program products usable to generate an interactive virtual environment. In particular, the described systems, methods and computer program products can enable a user to interact with the virtual environments and with any other users participating in the virtual environment through the interaction units. Users can be situated within an interaction unit in order to interact with the virtual environments and with any other users participating in the virtual environment.

An interaction unit can include a display device that provides a display of the interactive virtual environment. A user located in the interior portion of the interaction unit can view the display and may react using actions or gestures. A video capture device of the interaction unit can capture video data of the user during the interaction. The captured video data can also include a portion of the first display. The captured video data can be used to provide a second display of the interactive virtual environment on a display device of a second interaction unit. Optionally, the captured video data may be combined with other environment data (including video data captured from other interaction units) in order to generate the second display. The second display of the interactive virtual environment can include the first user displayed along with the captured portion of the first display. This may provide the user with a more natural experience of the virtual environment that is not constrained by the physical dimensions of a given interaction unit.

A second video capture device of the second interaction unit can capture video data of a second user located within that second interaction unit and a portion of the second display. The captured portion of the second display can include the first user and the captured portion of the first display. This captured data can then be combined with any additional content and used to provide a third display of the interactive virtual environment on a third display device of a third interaction unit. The third display of the interactive virtual environment can include the second user displayed along with the captured portion of the second display. The captured portion of the second display can include the first user and the captured portion of the first display thereby extending the user's experience of the virtual environment. Accordingly, the third display can include both the first and the second users displayed in the virtual environment.

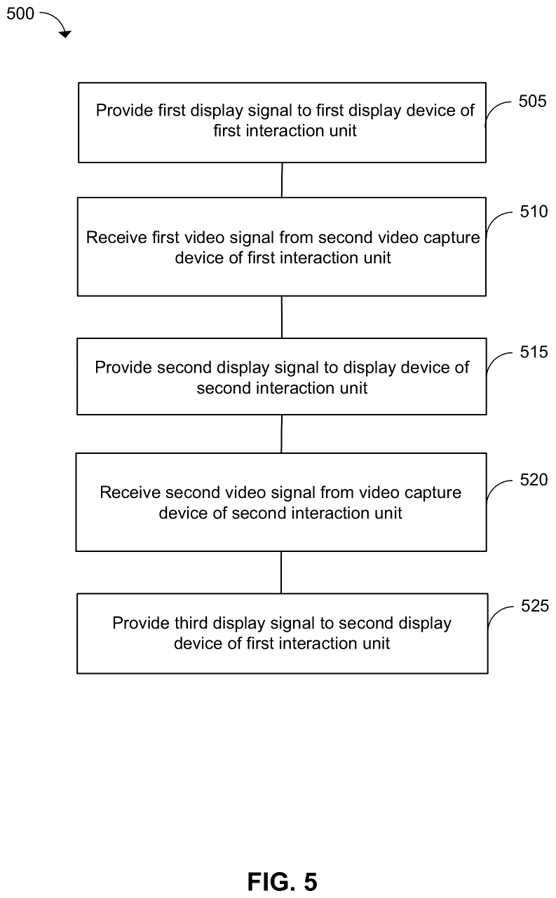

The described systems, methods and computer program products can display and capture video content in the manner described above for multiple interaction units to generate interactive virtual environments that include multiple levels of extended displays (including multiple users located in the interior portions of the multiple interaction units). The extensions of the displays may be controlled based on a virtual location and a virtual orientation of the multiple interaction units within the interactive virtual environment, as described in further detail herein below with reference to FIGS. 5-7.

The described systems, methods and computer program products can enable users to participate in the interactive virtual environment without requiring headgear devices. Headgear devices may cover a portion of the user's face and limit the ability of users to participate and interact with other users in the interactive virtual environment. This may allow users to interact more naturally within the virtual environment by ensuring that non-verbal cues, especially facial expressions, are conveyed directly to other users rather than obscured by headgear or translated into Avatars.

The present disclosure can provide a scalable virtual environment in which a large number of displays (including corresponding users) can be arranged within the interactive virtual environment with video data generating an extended view of the environment that scales as new users join.

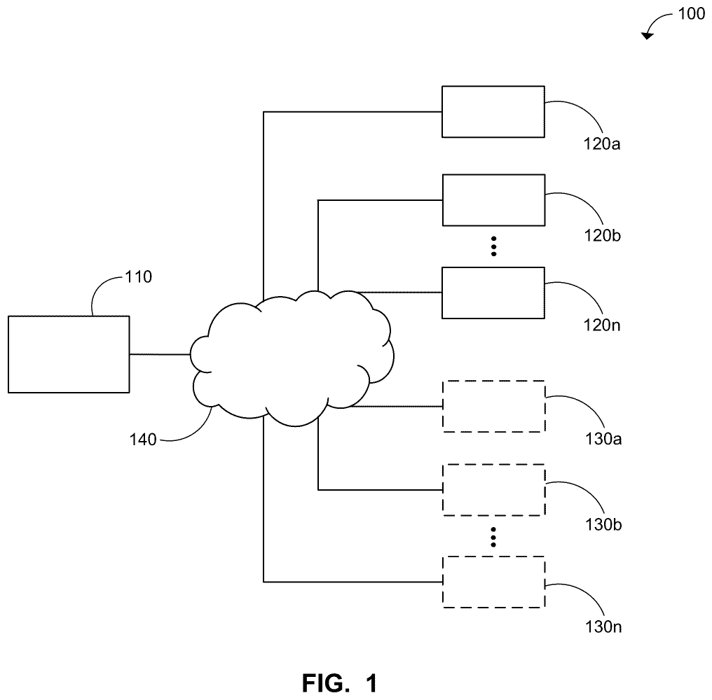

Referring now to FIG. 1, shown therein is a block diagram of an example system 100 for generating an interactive virtual environment. System 100 includes a control unit 110, a network 140 and multiple interaction units. The multiple interaction units can include a first plurality of interaction units in the form of physical environment units (PEUs) 120a-120n (which may also be collectively referred to as PEUs 120). Optionally, the interaction units can also include one or more physical display units (PDUs) 130a-130n (which may also be collectively referred to as PDUs 130).

Each interaction unit allows a user to interact with a virtual environment generated by the system 100. An interaction unit can include one or more video capture devices (e.g. video cameras) and one or more display devices. Each video capture device can be configured to capture video data relating to that interaction unit (and a user interacting with the virtual environment through that interaction unit). Each display device can be configured to display environmental data relating to the virtual environment (and, in some cases, other users interacting with the virtual environment).

An interaction unit generally includes a structure with at least one side, at least one video capture device and at least one display device. The structure of the interaction unit can define an interior portion within which a user can be positioned. The interaction unit may include at least two video capture devices usable to capture different perspectives of the interior portion of that interaction unit.

The video capture devices can be, for example, a video camera that captures a series of images. Optionally, control unit 110 can provide control inputs for the video capture device including field-of-view, focal length, zoom-level, and/or a framerate for capturing images for example.

The interaction unit may also include at least two display portions (which may or may not be separate display devices) to display video data of different portions of the virtual environment from the perspective of that interaction unit. Various different types of display devices can be used with the interaction units 120 and PDUs 130 The display devices can be curved or flat-screen devices. The display devices can be liquid crystal displays (LCDs), organic light emitting diode (OLED) displays, light emitting diode (LED) displays and/or other similar displays as is known by those skilled in the art. Optionally, a portion of the display device or the entire display device may be touch-sensitive and enable a user to interact with the interactive virtual environment using touch inputs. The display device can include a projector screen disposed along a side of the interaction unit and a projector configured to project images on the projector screen. Optionally, the side of the interaction unit itself may serve as the projector screen of the display device.

A first video capture device and a first display device of the interaction unit can be disposed along the same side of the interaction unit. The first video capture device can be positioned facing at least a portion of a second display device of that same interaction unit. During operation, the first video capture device can capture video data of at least the portion of the second display device and an interior portion of the interaction unit.

Optionally, the first video capture device and the second display device can be positioned opposite to each other along a common optical axis. The field-of-view of the first video capture device may be sufficiently large to capture video data of the entire display on the second display device.

Alternatively, the video capture devices and display devices within the interaction unit can be arranged with different optical axes. This may be the case, for example, where more than two video capture devices and/or display portions are provided.

In a similar manner, the second video capture device can be positioned facing at least a portion of the first display device. During operation, the second video capture device can capture video data of at least the portion of the first display device and an interior portion of the interaction unit.

During operation, a user may be located in the interior portion of the interaction unit. The user can view a display of the interactive virtual environment on the display devices within that interaction unit (although it should be apparent that the user might not be able to see all of the displays simultaneously because they are arranged around the interaction unit). This may allow the user to view different portions of the virtual interactive environment and provide a more immersive experience of the virtual environment.

The video capture devices can be positioned to capture video data of the user from two different perspectives. This can allow the interaction unit to be positioned at different locations within a virtual arrangement of interaction units within a virtual environment.

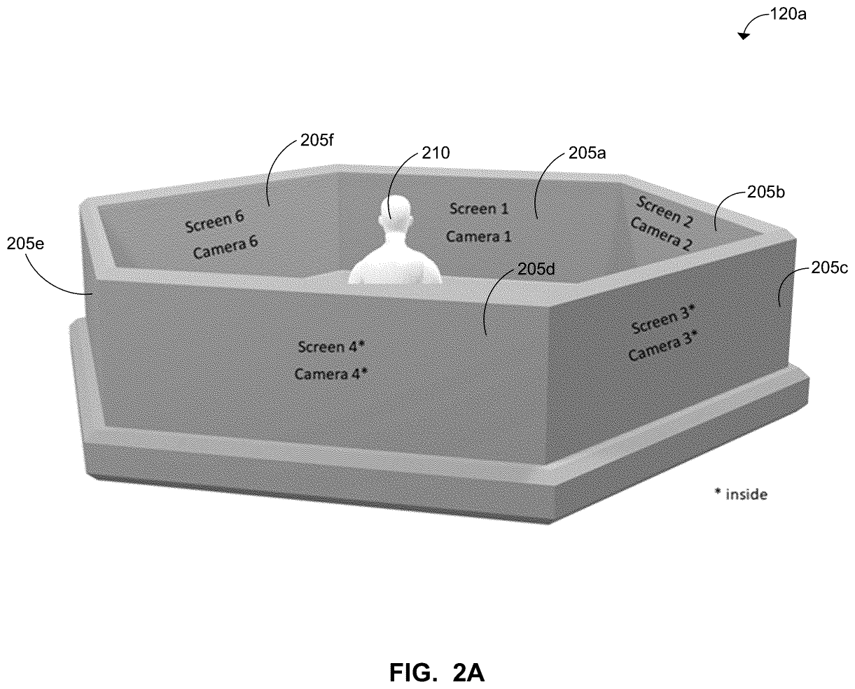

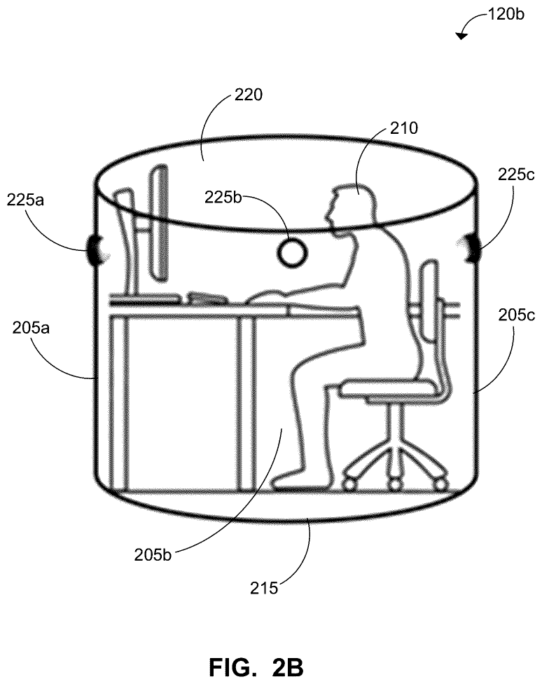

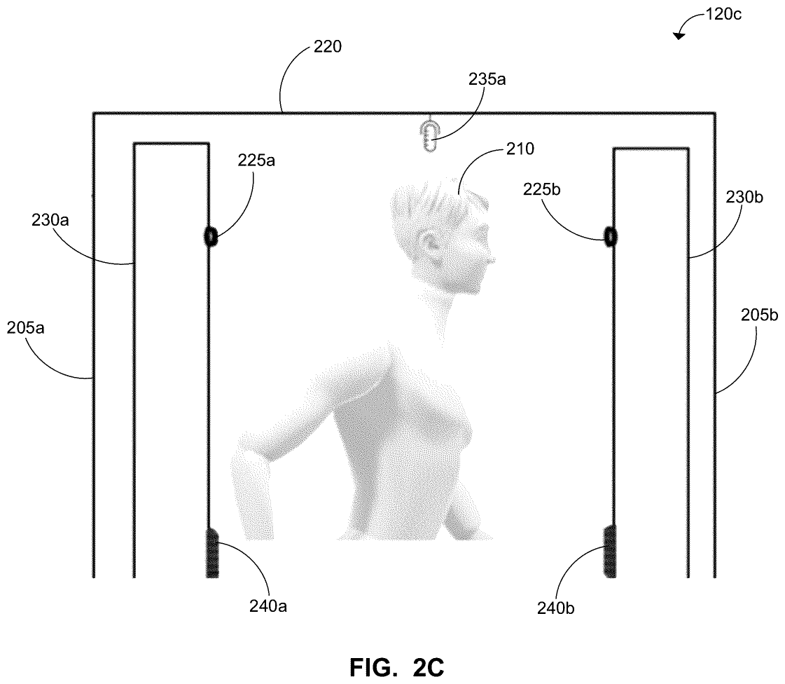

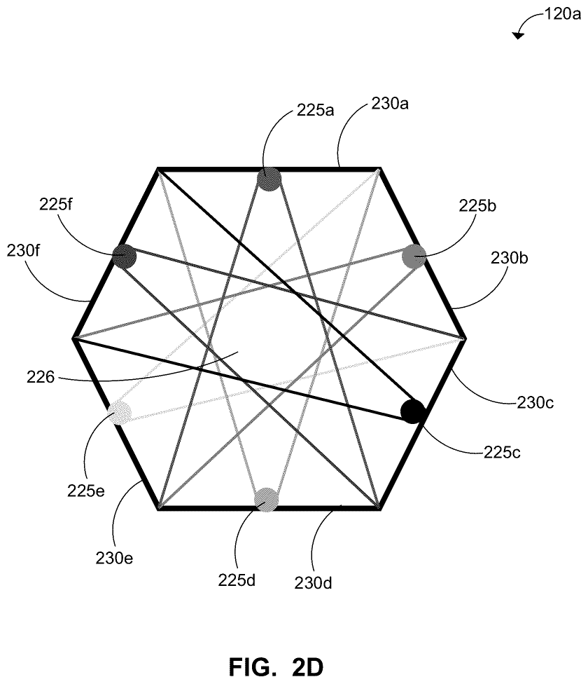

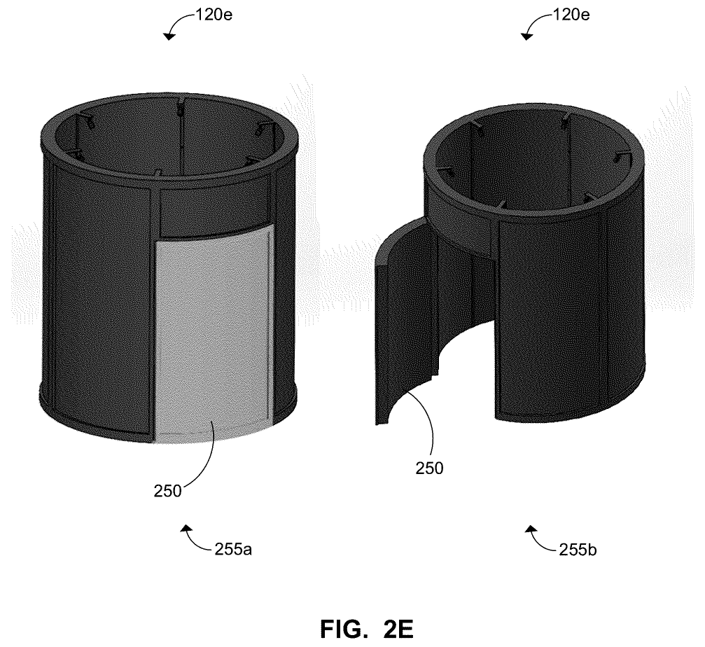

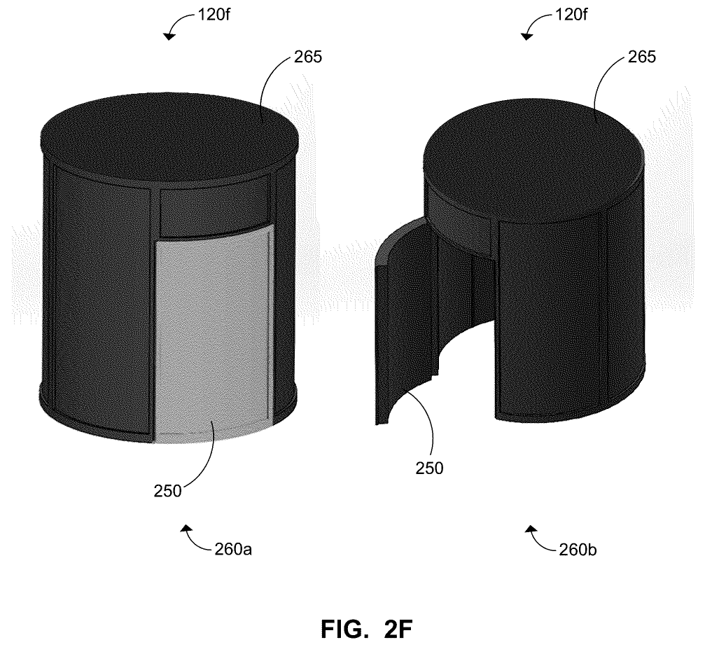

Optionally, an interaction unit can include a structure with multiple walls, a floor and/or a roof that partially or fully surround one or more users participating in the interactive virtual environment. For example, the interaction unit can be provided using a PEU, examples of which are described in further detail herein below with reference to FIGS. 2A-2F.

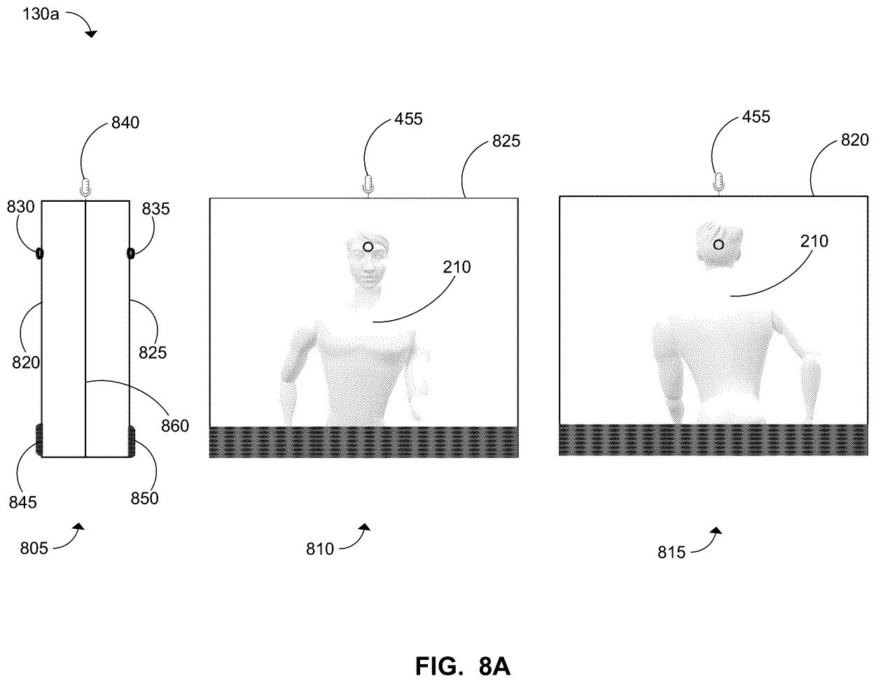

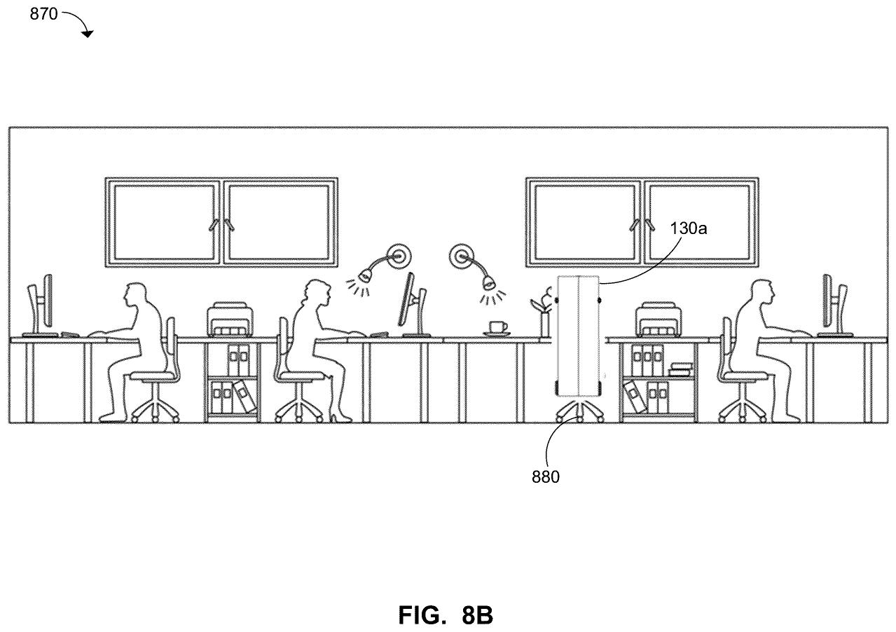

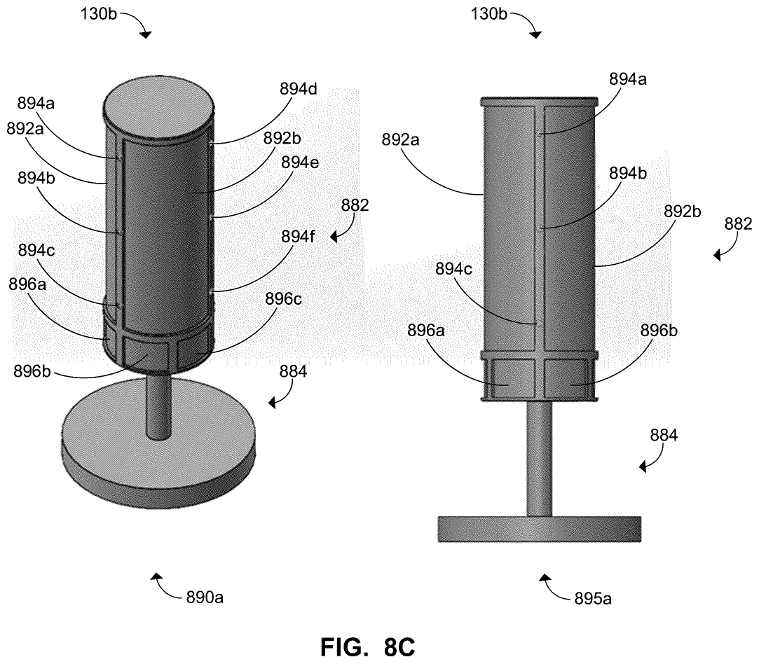

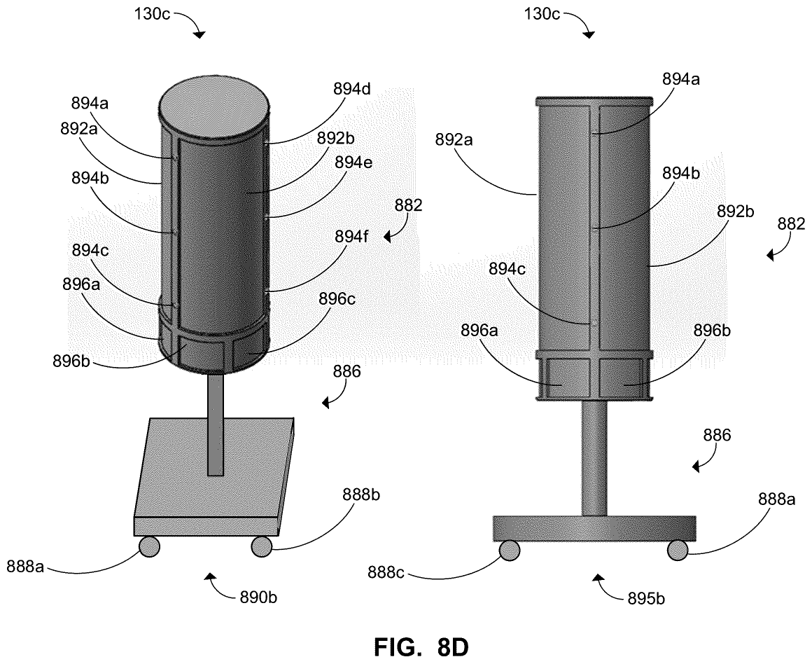

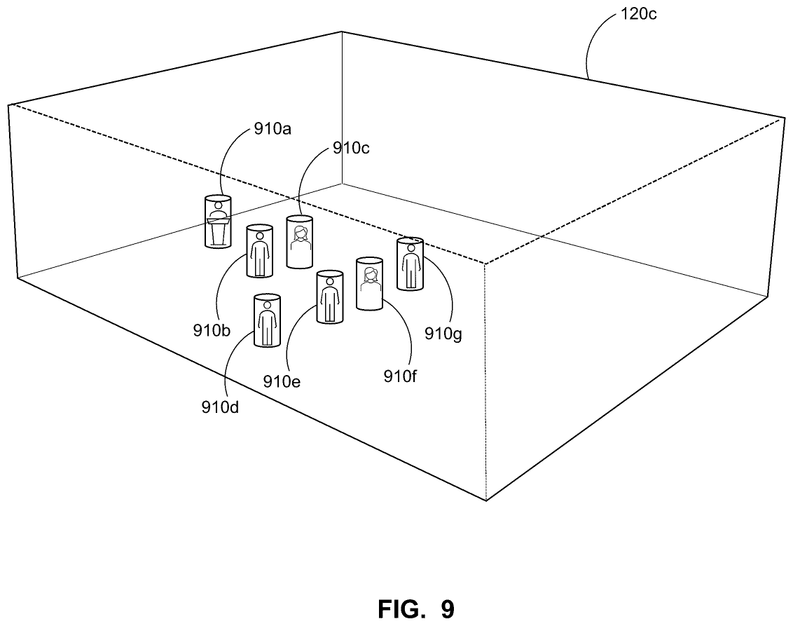

Optionally, an interaction unit can include an open structure that does not surround a user participating in the interactive virtual environment. For example, the interaction unit can be provided using a PDU, as described in further detail herein below with reference to FIGS. 8 and 9.

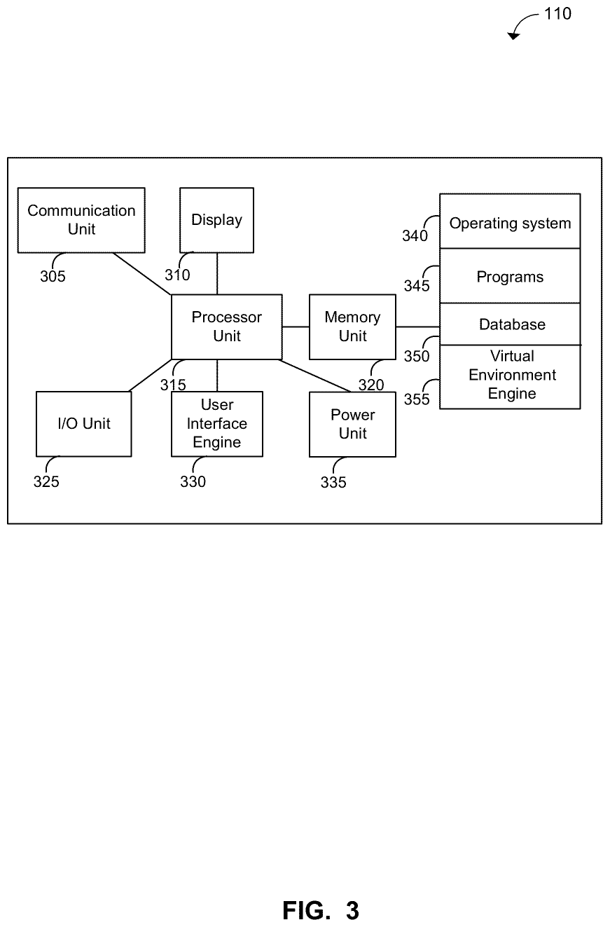

Control unit 110 typically includes a processing unit, an output device (such as a display, speaker, or tactile feedback device), a user interface, an interface unit for communicating with other devices, Input/Output (I/O) hardware, a wireless unit (e.g. a radio that communicates using CDMA, GSM, GPRS or Bluetooth protocol according to standards such as IEEE 802.11a, 802.11b, 802.11g, or 802.11n), a power unit and a memory unit. The memory unit can include RAM, ROM, one or more hard drives, one or more flash drives or some other suitable data storage elements such as disk drives, etc. An example control unit 110 is described in further detail herein below with reference to FIG. 3.

Control unit 110 can be communicatively coupled to the interaction units of system 100 using a wired or wireless connection. For example, the control unit 110 can be communicatively coupled to the interaction units by network 140. The control unit 110 can be configured to receive video signals from video capture devices of the interaction units using the network 140. The control unit 110 can be configured to provide display signals to the display devices of the multiple interaction units. Control unit 110 can be configured to implement various methods relating to the generation of interactive virtual environments, such as methods of virtually arranging interaction units within the interactive virtual environment (as described in further detail herein below with reference to FIGS. 5-7).

Network 140 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), 4G LTE, 5G NR (New Radio), etc.) and others, including any combination of these.

Referring now to FIGS. 2A-2F, shown therein are schematic views of example PEUs 120 that may be used with system 100. The example PEUs 120 shown in FIGS. 2A-2F define various configurations of interaction units having an interior portion in which a user can be positioned to interact with the virtual environment. A user 210 can be positioned within the interior portion of PEUs 120 to participate in the interactive virtual environment.

As shown in the examples illustrated, a PEU 120 can include multiple sides or walls 205. Various different shapes of PEUs 120 may be used. For example, PEUs 120 can be shaped as n-sided polygonal prisms (where n can be 3 or greater, e.g., a triangular prism, a cubic prism, a hexagonal prism, an octagonal prism etc.) or cylindrical prisms. Optionally, PEUs 120 may include a portion that is shaped as n-sided polygonal prism or cylindrical prism and may also include an additional portion that is differently shaped.

The PEU 120 can include display devices and video capture devices disposed along the walls 205. For example, a display device and a video capture device may be attached to each wall 205 of a PEU 120. Alternatively or in addition, a given wall 205 may include multiple display devices and/or video capture devices. Alternatively or in addition, a given wall 205 may not include any display devices and/or video capture devices.

Optionally, a PEU 120 may include a roof. Optionally, the roof may include one or more display segments. For example, the roof may be a dome shaped roof including one or more display segments forming a dome shaped display. The PEU 120 may also include a floor. Including a roof may allow the PEU 120 to fully enclose the interior portion of the PEU 120 (in some cases even in the absence of a floor provided by the PEU 120 so long as the PEU 120 is mounted on a substantially continuous floor). A fully enclosed PEU (i.e. a PEU configured with a fully enclosed interior portion) can fully surround a user 210 located in the interior of the PEU.

FIG. 2A shows a schematic perspective view of an example PEU 120a. As shown, the example PEU 120a is shaped as a hexagonal prism with walls 205a-205f laterally surrounding the user 210. Optionally, PEU 120a may include a floor and/or a roof (not shown in FIG. 2A).

As illustrated, the example PEU 120a can include display devices and video capture devices corresponding to each wall 205a-205f. That is, the PEU 120a includes six display devices and six video capture devices with one display device and one video capture device disposed along each wall 205a-205f. Each of the video capture devices may be operable to capture video data of the interior portion of PEU 120a and at least a portion of a display device facing that video capture device. For example, a video capture device disposed along wall 205a can be arranged to capture video data of user 210 and a portion of the display device disposed along opposite wall 205d.

FIG. 2B shows a schematic view of another example PEU 120b. As shown, the example PEU 120b can be shaped as a cylindrical prism that has a single, continuous cylindrical wall. Optionally, PEU 120b may include a floor and/or a roof (not shown in FIG. 2B). The cylindrical wall of PEU 120b can have multiple wall segments that partially or fully surround user 210 located in the interior portion of PEU 120b. For example, the cylindrical wall may include four wall sections including sections 205a-205c and a fourth wall section not shown in FIG. 2B).

PEU 120b can include one or more display devices disposed along the wall segments 205. Optionally, PEU 120b can include a single curved display device that substantially envelopes the interior portion of PEU 120b. Alternatively, PEU 120b can include multiple display devices or multiple segments of a single display device disposed along wall segments 205.

PEU 120b can also include one or more video capture devices. The PEU 120b can include a plurality of video capture devices disposed along each of the wall segments 205. As shown, the PEU 120b includes a plurality of video capture devices 225a-225c disposed along each of wall segments 205a-205c. Each of the video capture devices 225 can be configured for a wide field-of-view, for example, 120 degrees or larger. The combination of video capture devices 225 may provide a 360-degree view of the interior portion of PEU 120b and the display devices of PEU 120b.

FIG. 2C shows a schematic lateral view of a portion of another example PEU 120c. As shown, the example PEU 120c is shaped as a cubical prism. As shown in FIG. 2C, the PEU 120c includes a roof 220, and two walls 205a and 205b of PEU 120c.

In the example illustrated, the PEU 120c includes four display devices and four video capture devices. One display device and one video capture device is disposed along each wall. In the portion shown in FIG. 2C, device 230a and video capture device 225a disposed along wall 205a, and display device 230b and video capture device 225b disposed along wall 205b.

Each of the video capture devices 225a and 225b may be operable to capture video data of an interior portion of PEU 120c and a portion of a display device disposed on an opposite wall. For example, video capture device 225a can capture video data of user 210 and a portion of display device 230b. In a similar manner, video capture device 225b can capture video data of user 210 and a portion of display device 230a. When user 210 is facing display device 230b, as shown in FIG. 2C, video capture device 225b may capture user 210 from a front perspective and video capture device 225a may capture user 210 from a back perspective. Other video capture devices of PEU 120c (not shown in FIG. 2C) may capture user 210 from side perspectives. The video capture devices can also capture video that is displayed on the display devices 230 of the PEU 120c to extend the view of the virtual interactive environment that is captured beyond the PEU 120c itself.

The PEUs can also be configured to provide audio capture and audio playback for the virtual environment using one or more audio capture devices (e.g. a microphone) and one or more audio playback device (e.g. a speaker). As shown, PEU 120c includes an audio capture device 235a. PEU 120c also includes a plurality of audio playback devices 240a and 240b.

Audio capture device 235a can be positioned to capture audio data within the interior portion of PEU 120c. Optionally, a PEU such as the example PEU 120c may include multiple audio capture devices 235 (not shown).

Audio playback devices 240a and 240b may be positioned to provide surround sound or directional audio playback to user 210 located in the interior portion of PEU 120c. Optionally, a PEU such as the example PEU 120c may include greater or fewer numbers of audio playback devices.

Audio data captured by audio capture device 235a may include sounds generated by a user 210 located in the interior portion of PEU 120c. The captured audio data can be used by control unit 110 to provide an audio signal to an audio playback device of another interaction unit of system 100. The provided audio signal can be used to generate an audio output associated with the interactive virtual environment.

Control unit 110 may also provide an audio signal to audio playback devices 240a and 240b to generate an audio output associated with the interactive virtual environment within PEU 120c. The audio signal provided by control unit 110 may include audio data captured by an audio capture device of another interaction unit of system 100.

FIG. 2D shows a schematic top view illustrating positioning of the display devices 230a-230f and video capture devices 225a-225f in the example hexagonal prism shaped PEU 120a shown in FIG. 2A. FIG. 2D also illustrates the field-of-view captured by each of the example video capture devices 225.

In the example illustrated, each side of PEU 120a includes one display device and one video capture device. Alternatively, one or more sides of a PEU such as the example PEU 120a may include multiple display devices and/or multiple video capture devices. Alternatively or in addition, one or more sides of a PEU such as the example PEU 120a may omit a display device and/or video capture device.

As shown in FIG. 2D, video capture device 225a can capture video data of the interior portion 226 of PEU 120a and at least a portion of display device 230d. Video capture device 225b can capture video data of the interior portion 226 of PEU 120a and at least a portion of display device 230e. Video capture device 225c can capture video data of the interior portion 226 of PEU 120a and at least a portion of display device 230f. Video capture device 225d can capture video data of the interior portion 226 of PEU 120a and at least a portion of display device 230a. Video capture device 225e can capture video data of the interior portion 226 of PEU 120a and at least a portion of display device 230b. Video capture device 225f can capture video data of the interior portion 226 of PEU 120a and at least a portion of display device 230c. Accordingly, video capture devices 225a-225f can capture a 360-degree view of the interior portion of PEU 120a, from multiple perspectives, in combination with respective portions of display devices 230a-230f.

FIG. 2E shows perspective views 255a and 255b of another example PEU 120e. As shown, the example PEU 120e can be shaped as a cylindrical prism that has a single, continuous cylindrical wall and a door 250. Perspective view 255a shows door 250 in closed position. Door 250 may be closed, for example, when a user is present in the interior of PEU 120e and participating in an interactive virtual environment. Perspective view 255b shows door 250 in open position. Door 250 may be opened, for example, to enable a user to enter or exit the interior portion of PEU 120e.

In some embodiments, the cylindrical prism shaped PEU may also include a roof. FIG. 2F shows perspective views 260a and 260b of another example PEU 120f. As shown, the example PEU 120f can be shaped as a cylindrical prism that has a single, continuous cylindrical side wall, a door 250, and a roof 265. Perspective view 260a shows door 250 in closed position. Door 250 may be closed, for example, when a user is present in the interior of PEU 120f and participating in an interactive virtual environment. Roof 265 may enable an enhanced interactive virtual environment by providing acoustic isolation, lighting isolation etc. of the interior portion of PEU 120f from its surrounding environment. Perspective view 260b shows door 250 in open position. Door 250 may be opened, for example, to enable a user to enter or exit the interior portion of PEU 120f.

The PEUs 120 can be positioned at various locations to allow a user to engage with a virtual interactive environment. For example, a PEU 120 may be attached to a fixed structure such as a floor, a wall or any other fixed structure. Alternatively or in addition, a PEU may be mobile. For example, a PEU 120 may include wheels to allow the PEU 120 to be moved between different locations.

Optionally, a PEU 120 can include a motion simulator device. The motion simulator device can be configured to simulate movement of the PEU during operation of the PEU. The motion simulator can be configured to generate simulated motion that corresponds to, or aligns with, movement in the interactive virtual environment. For example, a PEU may include or be attached to a movable platform or other form of motion device.

Floor 215, roof 220, and/or walls 205 of PEUs 120 may be made of any natural or synthetic materials, as is known by those skilled in the art, to enable safe operation of the PEU and provide mechanical support to included devices and any users located in the interior portion of the PEU. PEUs can include seating arrangements and air circulation systems to provide a safe and comfortable interior environment for users participating in the interactive virtual environment.

Optionally, a PEU 120 may include an entrance such as a door or opening to access to the interior portion of the PEU. A user may enter (and exit) the PEU through the entrance to allow the user to participate in the virtual environment from the interior portion of the PEU. Optionally, the PEU may not be completely enclosed the entrance to the PEU may be provided through an opening in the exterior structure such as the top portion and/or between adjacent walls of the PEU.

Optionally, a PEU may include lighting fixtures (e.g., located on underside of optional roof 220) to provide consistent ambient lighting for the interior portion 226.

Optionally, a PEU may also include fixtures to provide AC power, DC power and/or battery power for operation of PEUs and any included and/or auxiliary devices.

Optionally, a PEU may include external video capture devices positioned to capture portions of the external surrounding environment (including any users located in the external surrounding environment) of the PEU.

A PEU can include an integrated computing system that includes a processor unit that, in combination with control unit 110, controls operations of the PEU. Ports for connecting input/output devices like a keyboard, a stylus, a drawing device, a disk drive and/or a joystick may also be included.

A PEU can further include networking components to enable communication using network 140. A PEU can also include additional communication interfaces (e.g., Bluetooth, HDMI, and/or USB interfaces) to provide alternative communication links to other electronic devices.

Optionally, a PEU 120 can include sensor devices configured to optimize performance of system 100 including, for example, a location sensor, an ambient light sensor, a motion sensor, a moisture sensor, a temperature sensor, an air pressure sensor, a proximity sensor, a fingerprint sensor, a facial recognition sensor and/or a LIDAR scanner.

Referring now to FIG. 3, shown therein is a block diagram of an example control unit 110. In the example illustrated, control unit 110 includes a communication unit 305, a display 310, a processor unit 315, a memory unit 320, an I/O unit 325, a user interface engine 330 and a power unit 335.

Communication unit 305 can include wired or wireless connection capabilities. Communication unit 305 can be used by control unit 110 to communicate with other devices or computers. For example, control unit 110 can use communication unit 305 to receive, via network 140, at least some of the video signals from video capture devices of the interaction units of system 100. Control unit 110 can also use communication unit 204 to receive, via network 140, audio signals from any audio capture devices included in the interaction units of system 100.

Control unit 110 can use the communication unit 204 to provide, via network 140, display signals to display devices of the interaction units of system 100. Control unit 110 can also use the communication unit 204 to provide, via network 140, audio signals to any audio playback devices included in the interaction units of system 100.

Processor unit 315 can control the operation of control unit 110. Processor unit 315 can be any suitable processor, controller or digital signal processor that can provide sufficient processing power depending on the configuration, purposes and requirements of control unit 110 as is known by those skilled in the art. For example, processor unit 315 may be a high-performance general processor. For example, processor unit 315 may include a standard processor, such as an Intel® processor, or an AMD® processor. Alternatively, processor unit 315 can include more than one processor with each processor being configured to perform different dedicated tasks. Alternatively, specialized hardware can be used provide some of the functions provided by processor unit 315.

Processor unit 315 may also control the operation of one or more of the multiple interaction units of system 100. For interaction units including an embedded computing system, processor unit 315 may provide instructions for control of the interaction unit to the embedded computing system.

Processor unit 315 can execute a user interface engine 330 that is used to generate various user interfaces. User interface engine 330 may be configured to provide a user interface on display 310. Optionally, control unit 110 may be in communication with external displays via network 140. User interface engine 330 may also generate user interface data for the external displays that are in communication with control unit 110.

User interface engine 330 can be configured to provide a user interface to enable set-up and initialization of the interaction units of system 100. User interface engine 330 can also be configured to provide a user interface to enable a virtual arrangement of the interaction units to generate the interactive virtual environment. For example, an administrator or operator of system 100 may provide instructions using the user interface to specify the virtual location and virtual orientation of the interaction units within the interactive virtual environment.

Optionally, user interface engine 330 can be configured to provide a user interface to enable modifications of an interactive virtual environment. For example, an administrator or operator of system 100 may provide instructions using the user interface to add or remove interaction units from the interactive virtual environment. An administrator or operator of system 100 may also provide instructions, using the user interface, to change the virtual location or virtual orientation of an interaction unit in the interactive virtual environment.

Display 310 may be a LED or LCD based display and may be a touch sensitive user input device that supports gestures. Display 310 may be integrated into control unit 110. Alternatively, display 310 may be located physically remote from control unit 110 and communicate with control unit 110 using network 140.

I/O unit 325 can include at least one of a mouse, a keyboard, a touch screen, a thumbwheel, a trackpad, a trackball, a card-reader, voice recognition software and the like, depending on the particular implementation of control unit 110. In some cases, some of these components can be integrated with one another.

Power unit 335 can be any suitable power source that provides power to control unit 110 such as a power adaptor or a rechargeable battery pack depending on the implementation of control unit 110 as is known by those skilled in the art.

Memory unit 320 includes software code for implementing an operating system 340, programs 345, database 350 and virtual environment engine 355.

Memory unit 320 can include RAM, ROM, one or more hard drives, one or more flash drives or some other suitable data storage elements such as disk drives, etc. Memory unit 320 can be used to store an operating system 340 and programs 345 as is commonly known by those skilled in the art. For instance, operating system 340 provides various basic operational processes for control unit 110. For example, the operating system 340 may be an operating system such as Windows® Server operating system, or Red Hat® Enterprise Linux (RHEL) operating system, or another operating system.

Database 350 may include a Structured Query Language (SQL) database such as PostgreSQL or MySQL or a not only SQL (NoSQL) database such as MongoDB, or Graph Databases, etc. Database 350 may be integrated with control unit 110. Alternatively, database 350 may run independently on a database server in network communication (e.g., via network 140) with control unit 110.

Database 350 may store the captured video data received from video capture devices of the interaction units of system 100. Database 350 may also store the captured audio data received from any audio capture devices included in the interaction units of system 100.

Optionally, database 350 may store stock video data and/or stock audio data that can be used in combination with the captured video data and/or captured audio data to generate the interactive virtual environment. The stock video data and/or stock audio data may be received from an external server (for example, via network 140) or may be generated by control unit 110. Alternatively or in addition, database 350 may store computer generated audio and/or video data that can be used in combination with the captured video data and/or stock video data and/or captured audio data and/or stock audio data to generate the interactive virtual environment. For example, database 350 may store stock video and/or stock audio data that includes metaverse environment data.

Programs 345 can include various programs so that control unit 110 can perform various functions such as, but not limited to, receiving video signals, providing display signals, receiving audio signals, providing audio signals, controlling the virtual location and virtual orientation of interaction units within the interactive virtual environment and providing control instructions to the interaction units of system 100.

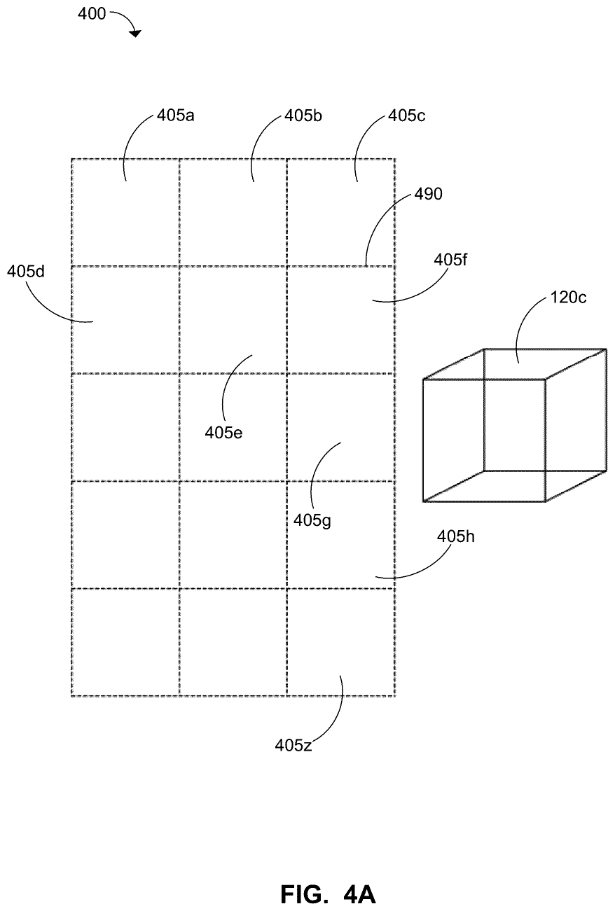

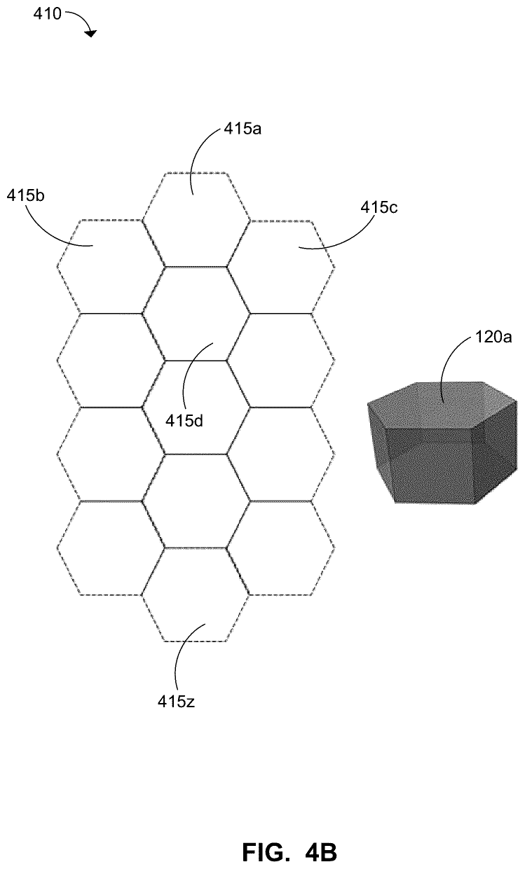

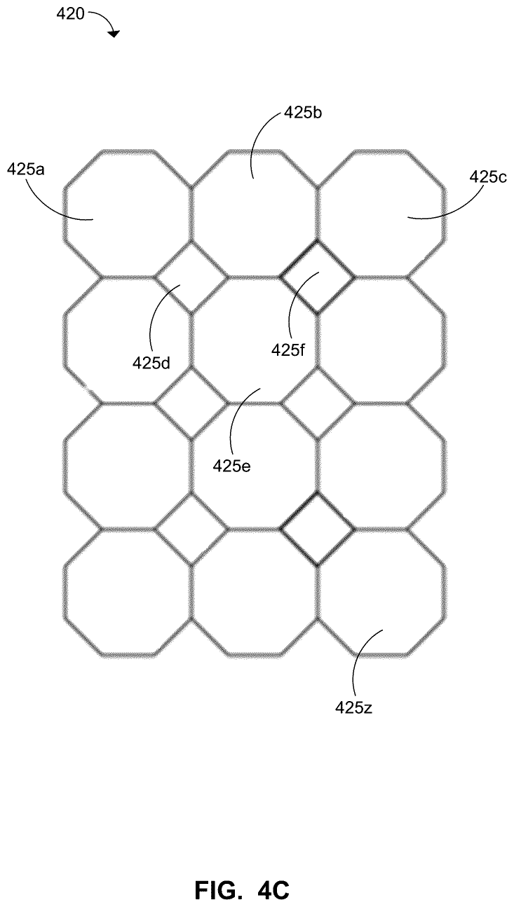

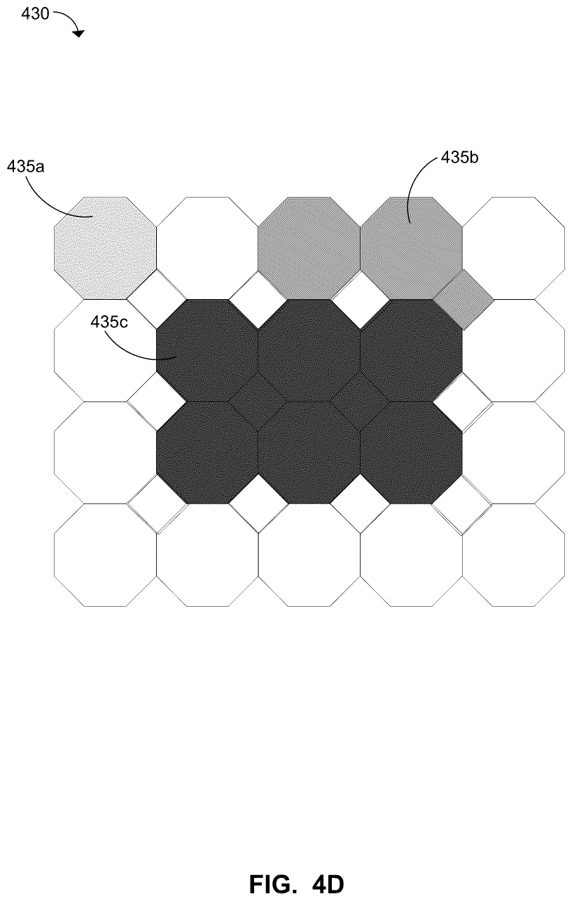

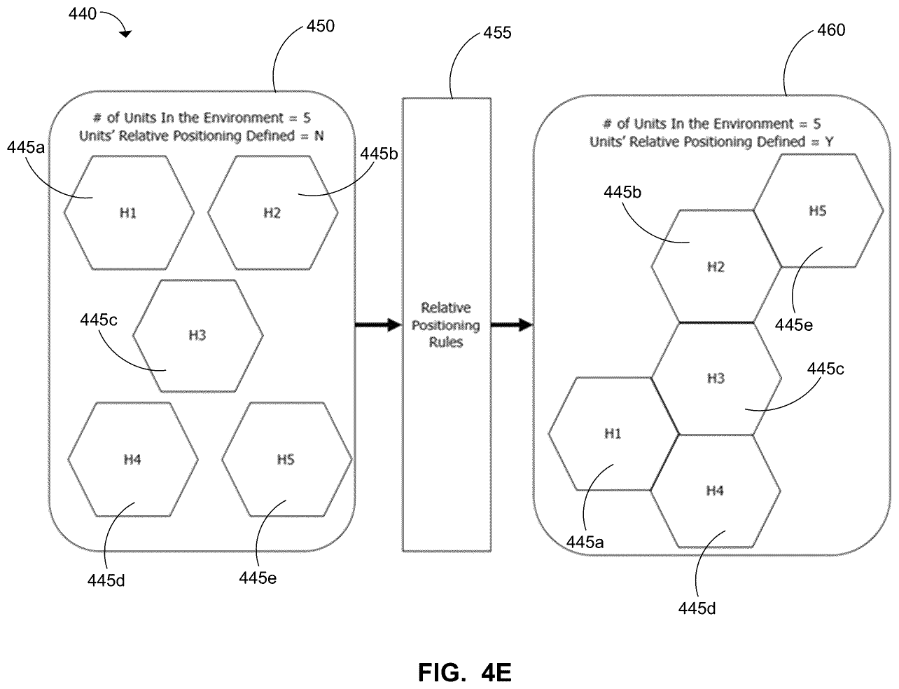

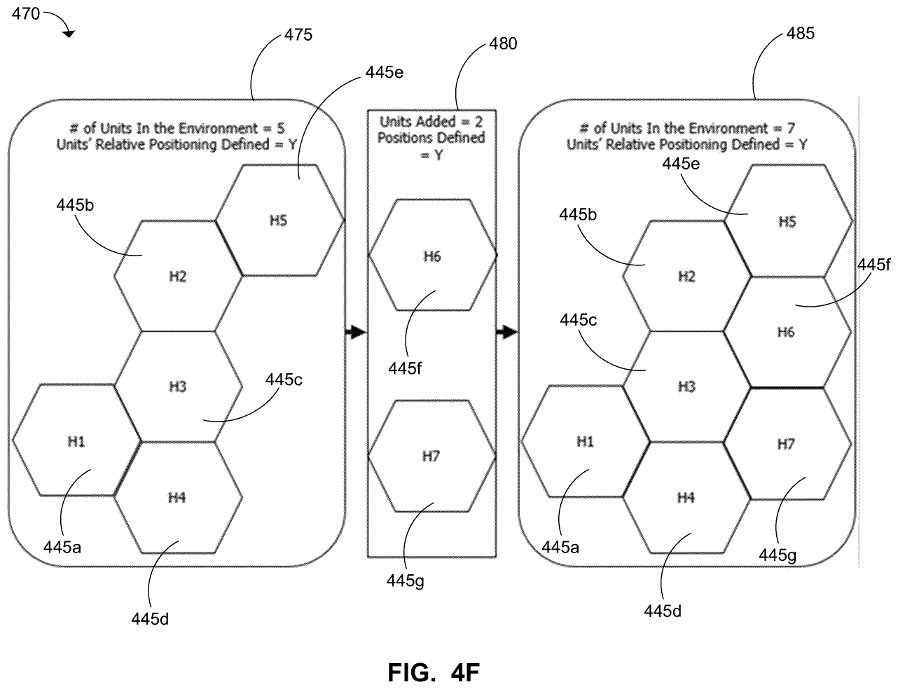

Virtual environment engine 355 can generate an interactive virtual environment by virtually arranging interaction units, for example, as described in further detail herein below with reference to FIGS. 4A-4F.

Virtual environment engine 355 can receive captured video data from the video capture devices of the multiple interaction units. Virtual environment engine 355 can also receive stock video data, for example, from database 350. Virtual environment engine 355 can generate display signals for each display device of the multiple interaction units using the captured video data and/or stock video data and/or computer-generated video data. Optionally, virtual environment engine 355 may generate display signals using metaverse environment data (e.g., metaverse environment data stored in database 350 and/or received from an external device).

Virtual environment engine 355 may not perform any processing of received captured video data before generating the display signals for each display device. This may reduce computational resource requirements for implementation of control unit 110 and/or reduce the latency times during operation of the interactive virtual environment.

Alternatively, virtual environment engine 355 may process received captured video data before generating the display signals for each display device. For example, virtual environment engine 355 may use stitching algorithms to combine captured video data from multiple video capture devices to generate a display signal for an example curved display device of a cylindrical prism-shaped interaction unit providing a panoramic view of the interactive virtual environment.

The generated display signal for each display device may be different corresponding to the virtual location and the virtual orientation of the display device within the virtual arrangement of the multiple interaction units, as described in further detail herein below with reference to FIGS. 5-7.

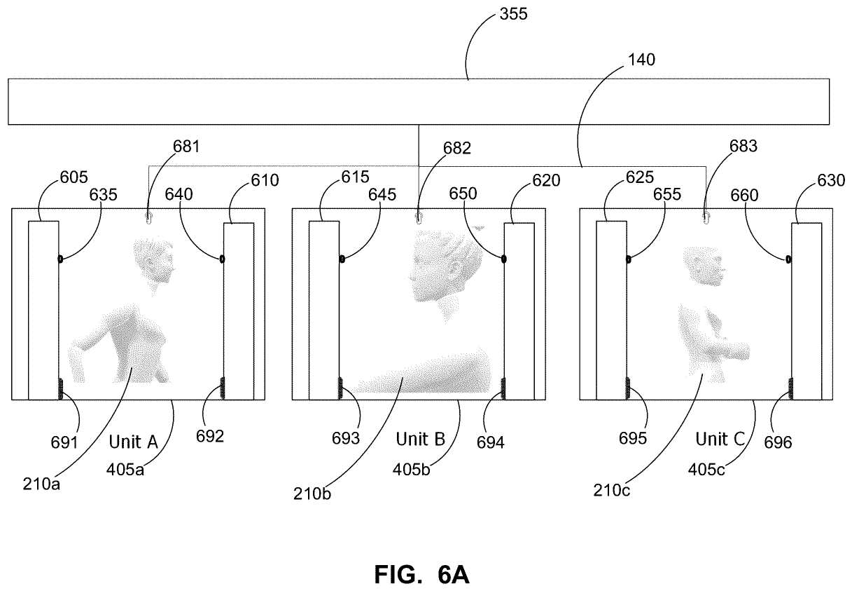

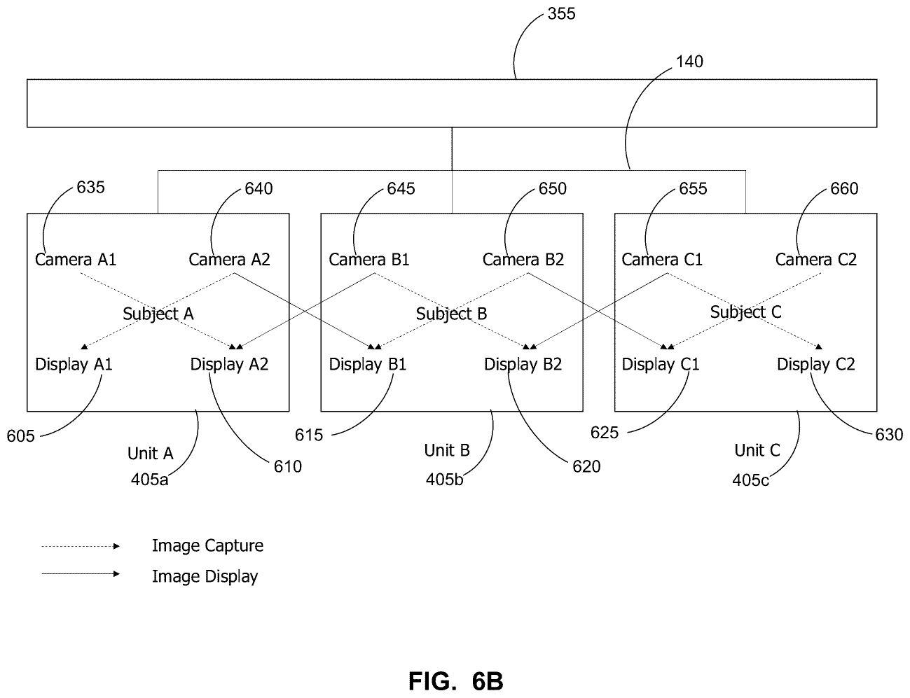

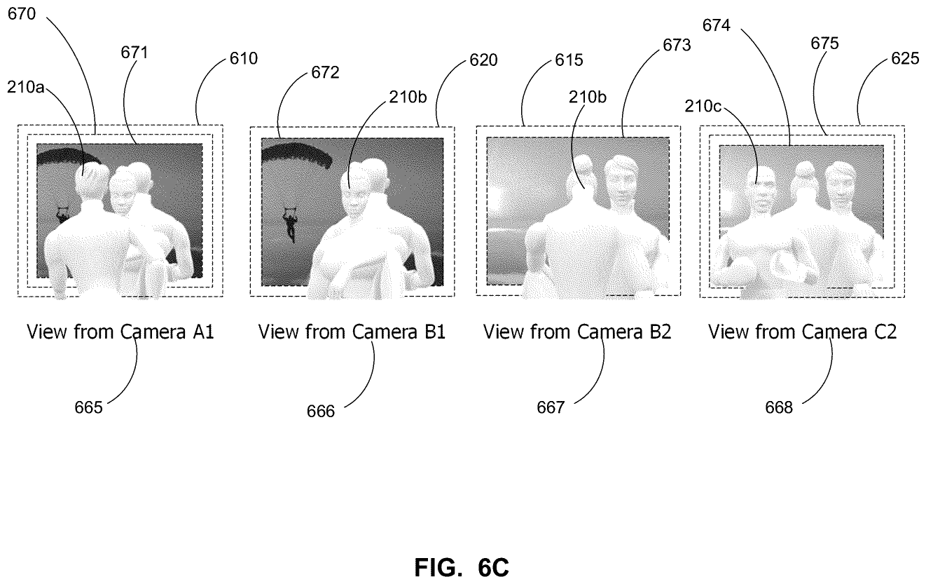

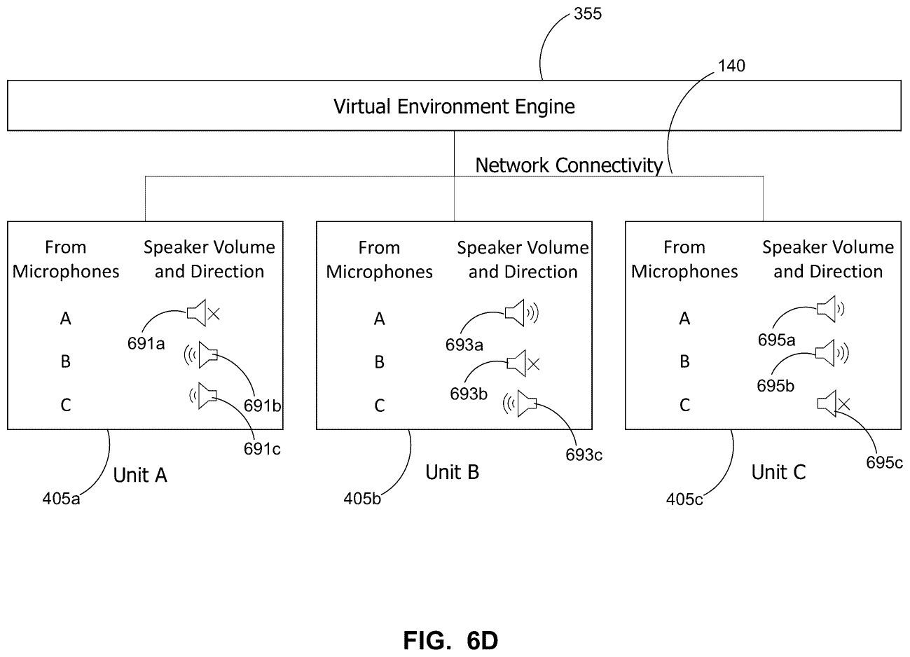

Virtual environment engine 355 can also receive captured audio data from the audio capture devices of the multiple interaction units. Virtual environment engine 355 can also receive stock audio data, for example, from database 350. Virtual environment engine 355 can generate audio signals for each audio playback device of the multiple interaction units using the captured audio data and/or stock audio data and/or computer-generated audio data. Optionally, virtual environment engine 355 may generate audio signals using metaverse environment data (e.g., metaverse environment data stored in database 350 and/or received from an external device). The generated audio signal for each audio playback device may be different corresponding to the virtual location and the virtual orientation of the audio playback device within the virtual arrangement of the multiple interaction units, as described in further detail herein below with reference to FIGS. 5 and 6.

Referring now to FIGS. 4A-4F, shown therein are schematic views illustrating virtual arrangements of multiple interaction units. The example virtual arrangements shown in FIGS. 4A-4F can be used generate an interactive virtual environment. Multiple interaction units can be virtually arranged to generate an interactive virtual environment that simulates a meeting room, an office space, a party hall, a public square, or a gaming universe. At least a portion of the interactive virtual environment can be generated using captured video data of interior portions of the interaction units. Accordingly, the size of the generated interactive virtual environment may depend on the number and the size of the interaction units included in the virtual arrangement.

The virtual arrangement may also be modified as users interact with the interactive virtual environment and/or users join or leave the virtual interactive environment. Accordingly, the size of the interactive virtual environment can also be scaled as additional interaction units are added to or removed from the virtual environment.

Optionally, one or more phantom interaction units may be included in the virtual arrangement used to generate the interactive virtual environment. A phantom interaction unit generally refers to an interaction unit that does not have an associated user who is participating in the virtual interactive environment.

A phantom interaction unit may be a PEU that does not include a user located in the interior portion of the PEU. That is, the phantom PEU may have a physical structure but does not have a user located in the interior portion who is participating in the ongoing virtual interactive environment, while other PEUs included in the virtual arrangement each include one or more users located in the interior portion. The phantom PEU can be included in the virtual arrangement to increase the size of the generated interactive virtual environment. Optionally, a user may enter the phantom PEU and begin participating in the interactive virtual environment.

Alternatively, a phantom interaction unit may not correspond to any real-world PEU. For example, the phantom interaction unit may not correspond to a real-world PEU and may only exist in the virtual environment (also referred to as a virtual phantom PEU). Computer generated or stock video data may be used to provide video data corresponding to the interior portion of the phantom interaction unit. The phantom interaction unit may be included in the virtual arrangement to increase the size of the generated interactive virtual environment or to provide varied virtual environments for users participating in the interactive virtual environment using other PEUs. A virtual phantom PEU may also allow the real-world PEUs to be arranged together despite variations in shape and dimension of the various PEUs.

FIG. 4A shows a schematic top view of an example virtual arrangement 400 of a plurality of PEUs that may be used to generate an interactive virtual environment, in this example cubic prism shaped PEUs 120c. As shown in FIG. 4A, the plurality of interaction units can be virtually arranged in a symmetrical fashion, in this case with multiple rows and columns. While virtual arrangement 400 has 5 rows and 3 columns, other examples may include different number of rows and/or columns. For example, the virtual arrangement may include a single row of 6 PEUs, or a single column of 10 PEUs, or 2 rows and 2 columns of PEUs, or various other combinations.

The virtual arrangement 400 shown in FIG. 4A can be used to define a virtual space of the interactive virtual environment. The virtual space can correspond to the interior portions of PEUs 405a-405z that are captured from multiple perspectives by the video capture devices of PEUs 405a-405z. The virtual arrangement 400 can define the relative positioning of the respective interaction units within the space of the virtual interactive environment.

Each PEU in virtual arrangement 400 may have one or more neighboring PEUs. Two PEUs can be neighboring PEUs if they are adjacent to each other along a side of the PEU but may not be neighboring PEUs if they only share a common vertex. For example, in virtual arrangement 400, PEU 405b has three neighboring PEUs-PEU 405a, PEU 405c and PEU 405e.

Alternatively, the virtual arrangement of interaction units may not be symmetric. For example, each row (or each column) may include a different number of PEUs. In some examples, the sides of the PEUs may be offset with respect to each other instead of being aligned at the vertices as shown in virtual arrangement 400. Alternatively, the interaction units may be arranged in an irregular fashion (e.g. without defined rows and/or columns).

FIG. 4B shows a schematic top view of a virtual arrangement 410 of hexagonal prism shaped PEUs 120a that may be used to generate an interactive virtual environment.

The example virtual arrangement 410 shown in FIG. 4B includes multiple hexagonal prism shaped PEUs 415a-415z arranged symmetrically. Each PEU in virtual arrangement 410 may have multiple neighboring PEUs. For example, in virtual arrangement 410, PEU 415a has three neighboring PEUs-PEU 415b, PEU 415c and PEU 415d.

Virtual arrangement 410 can define a virtual space that provides the interactive virtual environment. The virtual space can correspond to the interior portions of PEUs 415a-415z that are captured from multiple perspectives by the video capture devices of PEUs 415a-415z.

Optionally, the virtual arrangement may include PEUs of different shapes and/or sizes. For example, FIG. 4C shows a schematic top view of a virtual arrangement 420 of octagonal prism shaped PEUs (e.g., PEU 425a, PEU 425b, PEU 425c, PEU 425e, PEU 425z) and cubic prism shaped PEUs (e.g., PEU 425d, PEU 425f) that may be used to generate an interactive virtual environment.

Each PEU in virtual arrangement 420 may have one or more neighboring PEUs. For example, in virtual arrangement 420, PEU 425b has five neighboring PEUs—PEU 425a, PEU 425c, PEU 425d, PEU 425e and PEU 425f.

Virtual arrangement 420 can define a virtual space that provides the interactive virtual environment. The virtual space can correspond to the interior portions of PEUs 425a-425z that are captured from multiple perspectives by the video capture devices of PEUs 425a-425z.

FIG. 4D shows a schematic top view of a virtual arrangement 430 illustrating another example of a virtual arrangement including PEUs of different shapes and/or sizes. Virtual arrangement 430 includes, for example, PEU 435a, PEU 435b and PEU 435c that are each differently shaped and sized. In the illustrated example, PEU 435a is an octagonal prism shaped PEU. PEU 435b is a PEU including two octagonal prism and a cubic prism sub-units. PEU 435c is a PEU including six octagonal prism and two cubic prism sub-units.

Virtual arrangement 430 can define a virtual space that provides the interactive virtual environment. For example, video capture devices of PEU 435c may capture, from multiple perspectives, a user navigating the interior portion of PEU 435c. The captured video data can be used to display the user navigating the virtual space defined by virtual arrangement 430, as described in further detail below with reference to FIGS. 5-7.

Virtual arrangements 410, 420, or 430 can be generated by virtual environment engine 355 performing a virtual arrangement of PEUs 405, 415, 425 or 435. Virtual environment engine 355 may perform the virtual arrangement in response to input received from an administrator or operator of system 100. Virtual environment engine 355 may also perform the virtual arrangement automatically, for example, according to a schedule stored in database 350.

Virtual environment engine 355 can perform the virtual arrangement according to relative positioning rules for the multiple interaction units. The relative positioning rules may, for example, be stored in database 350 or provided by an administrator or operator of system 100.

The relative positioning rules can include global relative positioning rules that apply to all interaction units of system 100. For example, global relative positioning rules may specify a maximum total number of interaction units to include in a virtual arrangement or a maximum number of neighboring interaction units for any interaction unit included in the virtual arrangement.

The relative positioning rules can also include specific relative positioning rules that apply to specific interaction units of system 100. For example, specific relative positioning rules may specify a virtual location or a virtual orientation for a specific interaction unit, or allowed and disallowed neighboring interaction units for a specific interaction unit.

Virtual environment engine 355 can perform the virtual arrangement using interaction units that may be geographically located in distributed locations, for example, in different cities in different countries. Virtual environment engine 355 may, based on relative positioning rules, virtually arrange an interaction unit located in New York, USA and an interaction unit located in Toronto, Canada as neighboring interaction units in the virtual arrangement.

FIG. 4E shows an example method 440 of virtually arranging interaction units in the form of five hexagonal prism shaped PEUs 445a-445e. Method 440 may be performed, for example, by virtual environment engine 355.

At 450, virtual environment engine 355 can receive an input, from an administrator or an operator of system 100, to virtually arrange the interaction units 445a-445e. PEUs 445a-445e may be located in distributed geographical locations.

At 455, virtual environment engine 355 can receive relative positioning rules to perform the virtual arrangement of PEUs 445a-445e. The relative positioning rules may, for example, specify the virtual location and virtual orientation of each of PEUs 445a-445e.

At 460, virtual environment engine 355 can apply the relative positioning rules to perform the virtual arrangement of PEUs 445a-445e. Virtual environment engine 355 can further generate an interactive virtual environment using the virtual arrangement of PEUs 445a-445e to provide corresponding display signals and/or audio signals, as described in further detail herein below with reference to FIGS. 5-7.

FIG. 4F shows an example method 470 of modifying the virtual arrangement shown in FIG. 4E. In the example shown in FIG. 4F, the virtual arrangement is modified by adding two hexagonal prism shaped PEUs 445f and 445g. Method 470 may be performed, for example, by virtual environment engine 355.

At 475, virtual environment engine 355 can receive an input, from an administrator or an operator of system 100, to modify a virtual arrangement including PEUs 445a-445e. An administrator or operator may provide the input to add new PEUs (including new users located in the interior portions of the new PEUs) to an on-going interactive virtual environment.

At 480, virtual environment engine 355 can receive data for new PEUs 445f and 445g, and relative positioning rules specifying the virtual arrangement of new PEUs 445f and 445g. The relative positioning rules may, for example, specify the virtual location and virtual orientation of new PEUs 445f and 445g. In some examples, the relative positioning rules may also include changes in the virtual location and/or virtual orientation of PEUs 445a-445e.

At 485, virtual environment engine 355 can apply the relative positioning rules to perform the virtual arrangement of PEUs 445a-445g. An interactive virtual environment generated using the updated virtual arrangement can include captured video data from interior portions of PEUs 445f and 445g in addition to PEUs 445a-445e.

Referring now to FIG. 5, shown therein is a flowchart of an example method 500 for generating an interactive virtual environment. Method 500 can be implemented using, for example, virtual environment engine 355 of control unit 110.

Method 500 can be performed at various times. For example, method 500 may be performed in response to input received from an administrator or operator of system 100. Method 500 may also be performed in response to the detection of a user entering the interior portion of an interaction unit of system 100 or in response to a user providing an input using an I/O device of the interaction unit. Method 500 may also be performed automatically, for example, according to a schedule stored in database 350.

Method 500 can be performed in combination with a method for performing a virtual arrangement of multiple interaction units of system 100, for example, in combination with method 440. Method 500 may be used to generate the interactive virtual environment for one or more users located in the interior portions of the multiple interaction units included in the virtual arrangement.

Method 500 will be described with concurrent reference to FIGS. 6A-6B. FIGS. 6A and 6B show lateral schematic views of interaction units in the form of cubic PEUs 405a, 405b and 405c. As shown in FIG. 6A, users 210a, 210b and 210c are located respectively in the interior portions of the PEUs 405a, 405b and 405c.

PEU 405a includes display devices 605 and 610, PEU 405b includes display devices 615 and 620, and PEU 405c includes display devices 625 and 630. Virtual environment engine 355 may provide a display signal to each display device 605, 610, 615, 620, 625 and 630 using network 140.

As shown in FIG. 6A, display devices 610 and 615 may be disposed on adjacent and substantially parallel sides of neighboring PEUs 405a and 450b respectively. Similarly, display devices 620 and 625 may be disposed on adjacent and substantially parallel sides of neighboring PEUs 405b and 450c respectively.

Additionally, PEU 405a includes video capture devices 635 and 640, PEU 405b includes video capture devices 645 and 650, and PEU 405c includes video capture devices 655 and 660. Virtual environment engine 355 may receive a video signal from each video capture device 635, 640, 645, 650, 655 and 660 using network 140.

For the orientation of users 210a, 210b, and 210c shown in FIG. 6A, video capture device 635 can capture video data of at least a portion of display device 610 and user 210a from a back perspective. Video capture device 640 can capture video data of at least a portion of display device 605 and user 210a from a front perspective.

In a similar manner, video capture device 645 can capture video data of at least a portion of display device 620 and user 210b from a front perspective. Video capture device 650 can capture video data of at least a portion of display device 615 and user 210b from a back perspective.

Further, video capture device 655 can capture video data of at least a portion of display device 630 and user 210c from a back perspective. Video capture device 660 can capture video data of at least a portion of display device 625 and user 210c from a front perspective.

As shown in FIG. 6B, for neighboring PEUs 405a and 405b, virtual environment engine 355 can use the video signal received from video capture device 640 to provide the display signal to display device 615. Virtual environment engine 355 can also use the video signal from video capture device 645 to provide the display signal to display device 610.

In a similar manner, for neighboring PEUs 405b and 405c, virtual environment engine 355 can use the video signal received from video capture device 650 to provide the display signal to display device 625. Virtual environment engine 355 can also use the video signal from video capture device 655 to provide the display signal to display device 620.

Referring back now to FIG. 5, at 505, virtual environment engine 355 can provide a first display signal to a first display device of a first interaction unit. For example, PEU 405b can include a first display device 620, a second display device 615, a first video capture device 650 and a second video capture device 645. Virtual environment engine 355 can provide a first display signal to display device 620 of PEU 405b. Display device 620 can use the first display signal to generate a first display of the interactive virtual environment.

The first display may provide a first view into the interactive virtual environment from a perspective of display device 620. The perspective of display device 620 can be defined based on a virtual location and a virtual orientation of PEU 405b within the interactive virtual environment. For the example shown in FIG. 6A, the perspective of display device 620 can be defined as looking into PEU 405c from PEU 405b.

As described herein above with reference to FIG. 6B, the first display signal provided by virtual environment engine 355 to display device 620 can be based on a video signal received from video capture device 655 of PEU 405c. The received video signal may include captured video data of at least a portion of display device 630 and user 210c from a back perspective.

Virtual environment engine 355 may include all or a portion of the captured video data in the first display signal. For example, virtual environment engine 355 may exclude some of the captured video data by cropping out a portion of the video captured by video capture device 655. In some examples, virtual environment engine 355 may add additional video data, for example stock video data or computer generated video data, to the captured video data to generate the first display signal. Optionally, virtual environment engine 355 may add metaverse environment data to the captured video data to generate the first display signal.

At 510, virtual environment engine 355 can receive a first video signal from a second video capture device of the first interaction unit. For example, virtual environment engine 355 can receive a first video signal from video capture device 645 of PEU 405b. The first video signal can include captured video data of at least a portion of the first display being displayed on display device 620 and user 210b from a front perspective.

At 515, virtual environment engine 355 can provide a second display signal to a display device of a second interaction unit. For example, virtual environment engine 355 can provide a second display signal to display device 610 of PEU 405a. Display device 610 can use the second display signal to generate a second display of the interactive virtual environment.

The second display may provide a second view into the interactive virtual environment from a perspective of display device 610. The perspective of display device 610 can be defined based on a virtual location and a virtual orientation of PEU 405a within the interactive virtual environment. For the example shown in FIG. 6A, the perspective of display device 610 can be defined as looking into PEU 405b from PEU 405a.

The second display signal provided by virtual environment engine 355 to display device 610 can be based on the first video signal received, at 510, from video capture device 645 of PEU 405b. Accordingly, the second display signal may include all or a portion of the captured video data included in the first video signal. The second display signal may include at least a portion of display device 620 and user 210b from a front perspective. The portion of the captured data of display device 620 may include a portion of the first view including display device 630 and user 210c from a back perspective. Therefore, the second display on display device 610 can include a nested view of at least a portion of display device 630 within display device 620.

At 520, virtual environment engine 355 can receive a second video signal from a video capture device of the second interaction unit. For example, virtual environment engine 355 can receive a second video signal from video capture device 640 of PEU 405a. The second video signal can include captured video data of at least a portion of display device 605 and user 210a from a front perspective.

At 525, virtual environment engine 355 can provide a third display signal to the second display device of the first interaction unit. For example, virtual environment engine 355 can provide a third display signal to display device 615 of PEU 405b. Display device 615 can use the third display signal to generate a third display of the interactive virtual environment.

The third display may provide a third view into the interactive virtual environment from a perspective of display device 615. The perspective of display device 615 can be defined based on a virtual location and a virtual orientation of PEU 405b within the interactive virtual environment. For the example shown in FIG. 6A, the perspective of display device 615 can be defined as looking into PEU 405a from PEU 405b.

The third display signal provided by virtual environment engine 355 to display device 615 can be based on the second video signal received, at 520, from video capture device 640 of PEU 405a. Accordingly, the third display signal may include all or a portion of the captured video data included in the second video signal. The third display signal may include at least a portion of display device 605 and user 210a from a front perspective.

Referring now to FIG. 6C, shown therein are example images 665, 666, 667 and 668 that may be included in captured video data by video capture devices 635, 645, 650 and 660 respectively.

Virtual environment engine 355 may provide stock video data and/or computer generated video data (e.g., a person using a parachute) to display device 630 because there is no corresponding adjacent side of a neighboring PEU for display device 630. Video capture device 655 may capture user 210c from a back perspective and at least a portion of the stock video of a person using a parachute displayed on display device 630. Virtual environment engine 355 can use the captured video data to provide a display signal to display device 620. As shown in example image 666, video capture device 645 may capture user 210b from a front perspective. Video capture device 645 may also capture at least a portion of display device 620. The captured portion of display device 620 can include portion 672 displaying user 210c from a back perspective and a portion of the stock video of a person using a parachute.

Virtual environment engine 355 can use the captured video data from video capture device 645 (e.g., including example image 666) to provide a display signal to display device 610. As shown in example image 665, video capture device 635 may capture user 210a from a back perspective. Video capture device 635 may also capture at least a portion of display device 610. The captured portion of display device 610 can include portion 670 displaying user 210b from a front perspective and a nested display 671 including user 210c from a back perspective and a portion of the stock video of a person using a parachute.

Virtual environment engine 355 may provide stock video data and/or computer generated video data (e.g., a sky background) to display device 605 because there is no corresponding adjacent side of a neighboring PEU for display device 605. Video capture device 640 may capture user 210a from a front perspective and at least a portion of the sky background displayed on display device 605. Virtual environment engine 355 can use the captured video data to provide a display signal to display device 615. As shown in example image 667, video capture device 650 may capture user 210b from a back perspective. Video capture device 650 may also capture at least a portion of display device 615. The captured portion of display device 615 can include portion 673 displaying user 210a from a front perspective and a portion of the sky background.

Virtual environment engine 355 can use the captured video data from video capture device 650 (e.g., including example image 667) to provide a display signal to display device 625. As shown in example image 668, video capture device 660 may capture user 210c from a front perspective. Video capture device 660 may also capture at least a portion of display device 625. The captured portion of display device 625 can include portion 675 displaying user 210b from a back perspective and a nested display 674 including user 210a from a front perspective and a portion of the sky background.

While method 500 is described herein above with reference to three PEUs arranged in a row, method 500 can be extended to include any other number of PEUs. A user located in the interior portion of a PEU may be able to view nested displays corresponding to interior locations of multiple PEUs and any users located therein based on the viewing direction and the virtual arrangement of the multiple PEUs. For example virtual arrangement 400, a user located in the interior portion of PEU 405c viewing display device 490 of PEU 405c may view nested displays corresponding to interior portions of PEUs 405f, 405g, 405h and 405z.

Depending on factors including the size of the display devices, the captured video quality of the video capture devices and/or the video signal bit rates used, there can be a limited number of extending displays beyond which, any further displays may lack visual clarity. System 100 may include a stored setting (e.g., stored in database 350) that specifies a maximum number of extended displays to display on a display device. The setting may also be provided by an administrator or operator of system 100. Any nested displays in addition to the maximum number of nested displays may be collapsed or masked and hidden from display. Optionally, a user located in the interior portion of a PEU may provide an input (e.g., using I/O unit 325) to view the collapsed or masked nested displays. In response to the user input, virtual environment engine 355 may provide an expanded or magnified display of the collapsed/masked nested displays.

Optionally, method 500 can further include virtual environment engine 355 receiving audio signals from audio capture devices and providing audio signals to audio playback devices.

Each of PEUs 405a-405c can include an audio capture device 681-683 respectively. The audio capture device can be, for example, a microphone. Audio capture devices 681-683 can be positioned to capture audio data within the interior portion of the PEU. For example, audio capture device 681 can be positioned to capture audio data within the interior portion of PEU 405a including any audio signals provided by user 210a.

Each PEUs 405a-405c can also include multiple audio playback devices (e.g., speakers) to provide surround sound effects to a user located in the interior portion of the PEU. For example, PEU 405a includes audio playback devices 691 and 692, PEU 405b includes audio playback devices 693 and 694, and PEU 405c includes audio playback devices 695 and 696.

Virtual environment engine 355 can provide audio signals, including audio data captured by audio capture devices 681-683, to audio playback devices 691-696. Audio playback devices 691-696 can use the provided audio signals to generate audio outputs associated with the interactive virtual environment.

Referring now to FIG. 6D, shown therein is a schematic diagram showing routing of captured audio data to audio playback devices of PEUs 405a-405c based on the virtual location and virtual orientation of PEUs 405a-405c in the virtual arrangement. Each PEU 405a-405c can include one or more audio playback devices operable to provide sound effects to a user located in the interior portion of the respective PEU. For example, the audio playback devices may provide surround sound effects to a user located in the interior portion of the PEU, for example, using a single audio playback device that surrounds the user or using multiple audio playback devices positioned surrounding the user.

Virtual environment engine 355 can receive an audio signal including at least a portion of audio data captured by audio capture device 681 of PEU 405a. Similarly, virtual environment engine 355 can also receive audio signals including portions of audio data captured by audio capture devices 682 and 683 of PEU 405b and PEU 405c respectively.

Virtual environment engine 355 can provide an audio signal to one or more audio playback devices of PEU 405a based on the positioning of the audio playback devices and the virtual orientation of PEU 405a with respect to PEUs 405b and 405c. Virtual environment engine 355 can provide an audio signal to an audio playback device of PEU 405a that includes portions of audio data captured by audio capture devices 682 and 683. The speaker icons 691b and 691c correspond to portions of audio data captured by audio capture device 682 (positioned in PEU 405b) and audio capture device 683 (positioned in PEU 405C) respectively. The audio output volume or decibel level for the portion of audio data captured by audio capture devices 682 may be higher compared with the audio output volume or decibel level for the portion of audio data captured by audio capture devices 683 because the virtual distance between PEU 405a and PEU 405b is smaller compared with the virtual distance between PEU 405a and PEU 405c. As indicated by the speaker icon 691a, the audio data captured by audio capture device 681 may be omitted from the audio playback devices of PEU 405a.

The speaker icons 691b and 691c also illustrate the directionality of audio output provided by the audio playback devices of PEU 405a for the portion of the audio data captured by audio capture devices 682 and 683. In this example, the directionality of the audio output may be the same because both PEUs 405b and 405c are oriented in the same direction with respect to PEU 405a within the virtual arrangement.

In a similar manner, virtual environment engine 355 can provide portions of audio data captured by audio capture devices 681-683 to audio playback devices of PEUs 405b and 405c respectively. Speaker icons 693a-693c and 695a-695c show the audio output levels and directionality within PEUs 405b and 405c for the portions of audio data captured by audio capture devices 681-683.

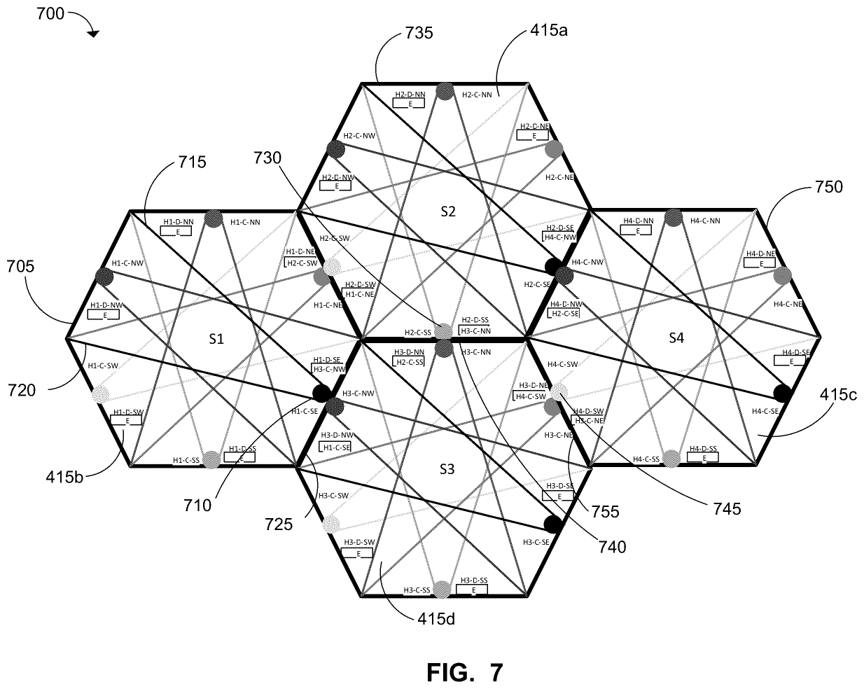

Virtual environment engine 355 can also perform method 500 for virtual arrangements that include differently shaped PEUs. Referring now to FIG. 7, shown therein is an example implementation 700 of method 500 for a portion of virtual arrangement 410 of hexagonal prism shaped PEUs shown in FIG. 4B. Implementation 700 includes hexagonal prism shaped PEUs 415a, 415b, 415c and 415d.

Each of PEUs 415a-415d can include six video capture devices and six display devices, with one video capture device and one display device disposed along each side of the PEU. Each video capture device can capture video data of an interior portion of the PEU and at least a portion of a display device disposed along a directionally opposite side of the PEU. For example, lines 715 and 720 may represent the field-of-view of video capture device 710 of PEU 415b and video capture device 710 can capture video of an interior portion of PEU 415b (including any user located in the interior portion of PEU 415b) and at least a portion of display device 705.

Virtual environment engine 355 can perform method 500 to generate an interactive virtual environment that includes PEUs 415a-415d. Virtual environment engine 355 may provide stock and/or computer-generated video data to display device 705 because there is no corresponding adjacent side of a neighboring PEU for display device 705.

Virtual environment engine 355 may receive a video signal from video capture device 710 including captured video data of an interior portion of PEU 415b and at least a portion of display device 705.

Virtual environment engine 355 may provide a display signal to display device 725 of PEU 415d that includes a portion of the captured video data received from video capture device 710.

In a similar manner, virtual environment engine 355 can provide display signals to each display device of PEUs 415a-415d based on the captured video data by neighboring video capture devices of the virtual arrangement.

For example, video capture device 730 can capture video of an interior portion of PEU 415a and at least a portion of display device 735. Virtual environment engine 355 may provide a display signal to display device 740 of PEU 415d that includes a portion of the captured video data received from video capture device 730.

As another example, video capture device 745 can capture video data of an interior portion of PEU 415c and at least a portion of display device 750. Virtual environment engine 355 may provide a display signal to display device 755 of PEU 415d that includes a portion of the captured video data received from video capture device 745.

Optionally, the structure of the interaction unit may not define an interior portion. For example, the interaction unit may be a PDU having a single wall that does not define an interior portion. The video capture devices of the PDU may be usable to capture different perspectives of the environment around the PDU (instead of an interior portion of the interaction unit).

Referring now to FIG. 8A, shown therein are schematic lateral view 805, front view 810 and rear view 815 of an example PDU 130a paired with example cubical prism shaped PEU 120c shown in FIG. 2C.

PDU 130a can include a display device 820 and a video capture device 830 disposed along a first side of PDU 130a. PDU 130a can also include a display device 825 and a video capture device 835 disposed along a second side of PDU 130a. The first side and the second side of PDU 130a can be opposite facing sides of wall 860. Optionally, the first side and the second side may be independent walls that are arranged adjacent and substantially parallel to each other along a common optical axis. Display devices 820, 825 and video capture devices 830, 835 can each be facing outwards from PDU 130a.

Referring now to FIG. 8B, shown therein is a schematic diagram illustrating placement of PDU 130a in a physical environment 870 (e.g., an office space). PDU 130a may be mobile and include, for example, wheels 880 to enable movement of PDU 130a to different locations.

Virtual environment engine 355 can generate an interactive virtual environment (e.g., using method 500) by pairing PDU 130a with PEU 120c. PEU 120c can be located in a geographically remote location from physical environment 870. The interactive virtual environment can enable a user 210 located in the interior portion of PEU 120c to be tele-present or virtually present in physical environment 870.

Video capture device 830 of PDU 130a can capture video data of surrounding physical environment 870 within the field-of-view of video capture device 830.

Virtual environment engine 355 can receive a video signal including the captured video data from video capture device 830. Virtual environment engine 355 can provide a display signal to display device 230a of PEU 120c to generate a first display of the interactive virtual environment on display device 230a.

Video capture device 225b of PEU 120c can capture video data of at least a portion of display device 230a (including the first display) and user 210 from a front perspective.

Virtual environment engine 355 can receive a video signal including the captured video data from video capture device 225b. Virtual environment engine 355 can provide a display signal to display device 825 to generate a second display of the interactive virtual environment on display device 825. The second display can include a portion of the captured video data including at least a portion of the first display on display device 230a and user 210 from a front perspective.

In a similar manner, video capture device 835 of PDU 130a can capture video data of surrounding physical environment 870 within the field-of-view of video capture device 835.

Virtual environment engine 355 can receive a video signal including the captured video data from video capture device 835. Virtual environment engine 355 can provide a display signal to display device 230b of PEU 120c to generate a third display of the interactive virtual environment on display device 230b.

Video capture device 225a of PEU 120c can capture video data of at least a portion of display device 230b (including the third display) and user 210 from a back perspective.

Virtual environment engine 355 can receive a video signal including the captured video data from video capture device 225a. Virtual environment engine 355 can provide a display signal to display device 820 to generate a fourth display of the interactive virtual environment on display device 820. The fourth display can include a portion of the captured video data including at least a portion of the third display on display device 230b and user 210 from a back perspective.

Optionally, virtual environment engine 355 can also receive audio data captured by audio capture device 235a of PEU 120c. The captured audio data may include any audio signals provided by user 210 located in the interior portion of PEU 120c.

Virtual environment engine 355 can provide an audio signal to audio playback devices 845 and 850 of PDU 130a to generate a first audio output associated with the interactive virtual environment. The provided audio signal can include at least a portion of the captured audio data by audio capture device 235a.

In a similar manner, virtual environment engine 355 can also receive audio data captured by audio capture device 840 of PDU 130a. The captured audio data may include any audio signals provided by one or more persons located in surrounding physical environment 870.

Virtual environment engine 355 can provide an audio signal to audio playback devices 240a and 240b of PEU 120c to generate a second audio output associated with the interactive virtual environment. The provided audio signal can include at least a portion of the captured audio data by audio capture device 840.

Virtual environment engine 355 can also generate interactive virtual environments by pairing PDUs and PEUs of shapes other than the cubical prism shape described herein above. Virtual environment engine 355 can provide display signals to display devices of the PDU-PEU pair including captured video data from the video capture devices of the PDU-PEU pair depending on the location and orientation of the display devices and video capture devices in the virtual arrangement of the PDU-PEU pair.

For example, a cylindrical prism shaped PDU can be paired with cylindrical prism shaped PEU 120b shown in FIG. 2B. The cylindrical prism shaped PDU can include one or more video capture devices operable to capture a 360-degree view of the physical environment of the PDU. Virtual environment engine 355 can use the captured video data to provide display on one or more display devices disposed along wall segments 205a and 205b of PEU 120b.

Virtual environment engine 355 can also use the captured video data by video capture devices 225 of PEU 120b to provide display signals for one or more display devices disposed along the outer side of the cylindrical prism shaped PDU.

Referring now to FIG. 8C, shown therein are a perspective view 890a and a side view 895a of an example PDU 130b. PDU 130b may include a cylindrical prism shaped portion 882 and a base portion 884. Base portion 884 may have any suitable design to provide mechanical support to cylindrical prism shaped portion 882 and to enable display devices disposed on cylindrical prism shaped portion 882 to be located at a suitable viewing height. Cylindrical prism shaped portion 882 can include multiple display devices 892, multiple video capture devices 894, multiple audio capture devices (not shown in FIG. 8C) and multiple audio playback devices 896.

In the illustrated example, PDU 130b includes display devices 892a and 892b. In other examples, PDU 130b may include a greater number of displays to provide additional views of the interactive virtual environment.

In the illustrated example, PDU 130b includes six video capture devices 894a-894f devices facing outwardly from PDU 130b. In other examples, PDU 130b may include fewer than six video capture devices to reduce total cost and/or complexity of PDU 130b. In other examples, PDU 130b may include greater than six video capture devices to capture additional video data of the surrounding environment of PDU 130b.

PDU 130b may be paired with a PEU, for example, cylindrical prism shaped PEU 120b shown in FIG. 2B. A virtual environment engine (e.g., virtual environment engine 355 shown in FIG. 3) can generate an interactive virtual environment (e.g., using method 500 of FIG. 5) by pairing PDU 130b with PEU 120b. The interactive virtual environment can enable a user 210 located in the interior portion of PEU 120b to be tele-present in a remote location where PDU 130b is located.

Video capture devices 894 of PDU 130b can capture video data of the surrounding physical environment of PDU 130b that is within the field-of-view of video capture devices 894.

Virtual environment engine 355 can receive a video signal including the captured video data from video capture devices 894. Virtual environment engine 355 can provide a display signal to display devices of PEU 120b to generate displays of the interactive virtual environment at PEU 120b that include the surrounding physical environment of PDU 130b. For example, the captured video data from multiple video capture devices 894a-894f may be combined to provide a 360 degree immersive virtual environment based on the surrounding environment of PDU 130b to a user located within PEU 120b.

Video capture device 225a of PEU 120b can capture video data of user 210 from a front perspective and of at least a portion of the displayed interactive virtual environment at PEU 120b. Virtual environment engine 355 can receive a video signal including the captured video data from video capture device 225a. Virtual environment engine 355 can provide a display signal to display device 892a to generate a display, at PDU 130b, of the interactive virtual environment including user 210 from a front perspective.

In a similar manner, video capture device 225c of PEU 120b can capture video data of user 210 from a back perspective and of at least a portion of the displayed interactive virtual environment at PEU 120b. Virtual environment engine 355 can receive a video signal including the captured video data from video capture device 225c. Virtual environment engine 355 can provide a display signal to display device 892b to generate a display, at PDU 130b, of the interactive virtual environment including user 210 from a back perspective.

Optionally, virtual environment engine 355 can also receive audio data captured by audio capture devices of PEU 120b. The captured audio data may include any audio signals provided by user 210 located in the interior portion of PEU 120b. Virtual environment engine 355 can provide an audio signal to audio playback devices 896 of PDU 130b to generate an audio output associated with the interactive virtual environment at PDU 130b.

Optionally, PDU 130b may include one or more audio capture devices (not shown in FIG. 8C). Virtual environment engine 355 can receive audio data captured by the audio capture devices of PDU 130b. The captured audio data may include any audio signals provided by one or more persons located in the surrounding physical environment of PDU 130b. Virtual environment engine 355 can provide an audio signal to audio playback devices of PEU 120b to generate audio output associated with the interactive virtual environment at PEU 120b.

Optionally, PDUs may be implemented as mobile robot devices. A majority portion of a display device of the mobile robot PDU may display a head portion of a user thereby providing mobile telepresence for the user located remotely from the PDU. The user may, for example, be located in the interior portion of a PEU that is paired with the mobile robot PDU. A control unit may control a video capture device of the PEU to focus the captured video data on the head portion of the user. Alternatively, control unit may process captured video data of the entire user to focus on the head portion and provided the processed video data to the display device of the mobile robot PDU.

Optionally, a PDU may have a smaller size compared with a PEU paired with the PDU. For example, the diameter of a cylindrical prism shaped PDU may be in a range from 10% to 60% of a cylindrical prism shaped PEU that is paired with the PDU. If the PDU is the same size as the PEU, then a user image may appear distorted (e.g., unusually large compared with surround environment of the PDU) when an unprocessed user image captured by the PEU is displayed at the PDU. Alternatively, the PDU and PEU may be similar-sized and video data captured at the PEU may be processed, to avoid the distortion effect, before it is provided to the display device of the PDU.

Referring now to FIG. 8D, shown therein are a perspective view 890b and a side view 895b of an example PDU 130c. PDU 130c may include a cylindrical prism shaped portion 882 (similar to PDU 130b shown in FIG. 8C) and a base portion 886. Base portion 886 may have any suitable design to provide mechanical support to cylindrical prism shaped portion 882, to enable display devices disposed on cylindrical prism shaped portion 882 to be located at a suitable viewing height, and to enable easy movement of PDU 130c.

Base portion 886 may include any suitable design to enable PDU 130c to be easily moved to different locations. For example, base portion 886 may include four omnidirectional wheels 888, two of which are visible in each of the illustrated views (e.g., wheels 888a and 888b shown in perspective view 890b; and wheels 888a and 888c shown in side view 895b).

As described herein above with reference to PDU 130b (shown in FIG. 8C), cylindrical prism shaped portion 882 can include multiple display devices 892, multiple video capture devices 894, multiple audio capture devices (not shown in FIG. 8D) and multiple audio playback devices 896.

As described herein above with reference to PDU 130b (shown in FIG. 8C), PDU 130c may be paired with a PEU, for example, cylindrical prism shaped PEU 120b shown in FIG. 2B. A virtual environment engine can generate an interactive virtual environment by pairing PDU 130c with PEU 120b. The interactive virtual environment can enable a user located in the interior portion of PEU 120b to be tele-present in a remote location where PDU 130c is located.

Referring now to FIG. 9, shown therein is a schematic diagram of multiple cylindrical prism shaped PDUs 910a-910g located in the interior portion of a cubical prism shaped PEU 120c. Optionally, PDUs 910a-910g may be located in a shared physical environment, e.g., a conference center. Each of PDUs 910a-910g can be paired with a PEU that may be geographically remotely located from PEU 120c.

As described herein above with reference to FIGS. 8A and 8B, virtual environment engine 355 can generate an interactive virtual environment to enable users located in the interior portion of the paired PEUs to be tele-present or virtually present in the physical environment of the PDU, which in this example can be the interior portion of PEU 120c. Each of the paired PEUs may include one or more users located in the interior portion of the PEU.

One or more video capture devices of each of PDUs 910a-910g can capture video data of the surrounding physical environment of the PDU. The surrounding physical environment can include an interior portion of PEU 120c, and other PDUs and portions of any display devices of PEU 120c that are within the field of view of the video capture device.

In the example shown in FIG. 9, PDUs 910a-910g are located in the interior portion of a cubical prism shaped PEU. Alternatively, PDUs 910a-910g can be located in the interior portion of a differently shaped PEU.

Furthermore, in the example shown in FIG. 9, PDUs 910a-910g are cylindrical prism shaped PDUs. Alternatively, PDUs 910a-910g can include a combination of one or more differently shaped PDUs. For example, one or more PDUs 910a-910g can include a dome shaped roof having one or more display segments forming a dome shaped display.

As will be apparent to a person of skill in the art, certain adaptations and modifications of the described methods can be made, and the above discussed examples should be considered to be illustrative and not restrictive.

While the above description describes features of example systems, methods and computer program products, it will be appreciated that some features and/or functions of the described examples are susceptible to modification without departing from the spirit and principles of operation of the described examples. For example, the various characteristics which are described by means of the represented examples may be selectively combined with each other. In other instances, well-known methods, procedures and components have not been described in detail so as not to obscure the description of the examples. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred examples, but should be given the broadest interpretation consistent with the description as a whole.

We claim:

1. A system for generating an interactive virtual environment, the system comprising:
a processor in communication with a first interaction unit, the first interaction unit comprising:
a first display device;
a first video capture device, wherein the first display device and the first video capture device are disposed along a first side of the interaction unit;
a second display device, wherein the first video capture device is positioned facing at least a portion of the second display device and the first video capture device is operable to capture video data of an interior portion of the first interaction unit and the at least a portion of the second display device from a first perspective; and
a second video capture device, wherein the second video capture device is positioned facing at least a portion of the first display device and the second video capture device is operable to capture video data of the interior portion of the first interaction unit and the at least a portion of the first display device from a second perspective; and
a data storage unit storing instructions executable by the processor;
wherein the processor is configured to:
provide a first display signal to the first display device, the first display signal usable to generate a first display of the interactive virtual environment on the first display device, wherein the first display comprises a first view into the interactive virtual environment from a perspective of the first display device, wherein the perspective of the first display device is defined based on a virtual location and a virtual orientation of the first interaction unit within the interactive virtual environment;
receive a first video signal from the second video capture device, the first video signal comprising captured video data, from the second perspective, of the interior portion of the first interaction unit and at least a portion of the first display of the interactive virtual environment on the first display device; and
provide a second display signal to a display device of a second interaction unit, the second display signal based on the first video signal and usable to generate a second display of the interactive virtual environment on the display device of the second interaction unit, wherein the second display comprises a second view into the interactive virtual environment, the second view including a portion of the interior portion of the first interaction unit and the at least a portion of the first display from a perspective of the display device of the second interaction unit.

2. The system of claim 1, wherein the processor is further configured to:
receive a second video signal from a video capture device of the second interaction unit, the second video signal comprising video data of an interior of the second interaction unit; and
provide a third display signal to the second display device, the third display signal based on the second video signal and usable to generate a third display of the interactive virtual environment on the second display device, wherein the third display comprises a third view into the interactive virtual environment, the third view including a portion of the environment of the second interaction unit from a perspective of the second display device, wherein the perspective of the second display device is defined based on the virtual location and the virtual orientation of the first interaction unit within the interactive virtual environment.

3. The system of claim 1, wherein the first display signal is based on a third video signal received from a video capture device of a third interaction unit, the third video signal comprising captured video data of the interior portion of the third interaction unit, and the first view includes a portion of the interior portion of the third interaction unit.

4. The system of claim 1, wherein the first interaction unit comprises three or more display devices and three or more video capture devices, wherein:
each given video capture device of the three or more video capture devices is positioned facing at least a portion of a given display device of the three or more display devices and the given video capture device is operable to capture video data of the interior portion of the first interaction unit and the at least a portion of the given display device from a given perspective of the multiple perspectives;
and the processor is further configured to provide a given display signal to each given display device of the three or more display devices, the given display signal usable to generate a given display of the interactive virtual environment on the given display device, wherein the given display comprises a given view into the interactive virtual environment from a respective perspective of the given display device, wherein each given view is determined based on the virtual location and virtual orientation of the first interaction unit within the interactive virtual environment.

5. The system of claim 1, wherein:
the first interaction unit further comprises a first audio playback device, and a first audio capture device positioned to capture audio data within the interior portion of the first interaction unit; and
the processor is further configured to:
provide a first audio signal to the first audio playback device, the first audio signal usable to generate a first audio output associated with the interactive virtual environment by the first audio playback device, wherein the first audio signal includes at least portion of audio data captured by an audio capture device of the second interaction unit; and
provide a second audio signal to an audio playback device of the second interaction unit, the second audio signal usable to generate a second audio output associated with the interactive virtual environment by the audio playback device of the second interaction unit, wherein the second audio signal includes at least a portion of audio data captured by the first audio capture device.

6. The system of claim 5, wherein the output volume level of the first audio playback device associated with the portion of audio data captured by the audio capture device of the second interaction unit is based on a virtual distance between the virtual location of the first interaction unit and a second virtual location of the second interaction unit in the interactive virtual environment.

7. The system of claim 1, wherein the first interaction unit and the second interaction unit are virtually arranged within the interactive virtual environment such that:
the second display device and the second video capture device are virtually disposed along a second side of the first interaction unit; and
the display device of the second interaction unit is disposed along a side of the second interaction unit; and
the processor is further configured to virtually position the first interaction unit and the second interaction unit adjacent to each other in the interactive virtual environment by positioning the second side of the first interaction unit and the side of the second interaction unit adjacent and substantially parallel to each other in the interactive virtual environment.

8. The system of claim 1, wherein the interactive virtual environment comprises a plurality of virtual interaction units arranged within the interactive virtual environment, the plurality of virtual interaction units including a first plurality of physical interaction units having corresponding physical interaction units capable of receiving one or more users therewithin and at least one phantom interaction unit that does not correspond to any in-use physical interaction unit.

9. The system of claim 2, wherein the first interaction unit is provided using a physical environment unit (PEU) comprising multiple walls and a floor configured to fully surround a user while the user participates in the interactive virtual environment, and the second interaction unit is provided as a physical display unit (PDU) comprising a first side and a second side arranged adjacent and substantially parallel to each other along a common optical axis, the display device and the video capture device of the second interaction unit being disposed along the first side of the PDU; and wherein the processor is further configured to:
provide a fourth display signal to a second display device of the second interaction unit disposed along the second side of the PDU, the fourth display signal usable to generate a fourth display of the interactive virtual environment on the second display device of the second interaction unit, wherein the fourth display comprises a fourth view into the interactive virtual environment, the fourth view including a portion of the interior portion of the first interaction unit and the generated third display; and
wherein the first display includes video data of the environment of the PDU captured by a second video capture device of the second interaction unit disposed along the second side of the PDU.

10. A method for generating an interactive virtual environment, the method implemented by a processor executing instructions stored on a data storage unit, the processor in communication with a first interaction unit comprising:
a first display device;
a first video capture device, wherein the first display device and the first video capture device are disposed along a first side of the interaction unit;
a second display device, wherein the first video capture device is positioned facing at least a portion of the second display device and the first video capture device is operable to capture video data of an interior portion of the first interaction unit and the at least a portion of the second display device from a first perspective; and
a second video capture device, wherein the second video capture device is positioned facing at least a portion of the first display device and the second video capture device is operable to capture video data of the interior portion of the first interaction unit and the at least a portion of the first display device from a second perspective, and
wherein the method comprises:
providing, by the processor, a first display signal to the first display device, the first display signal usable to generate a first display of the interactive virtual environment on the first display device, wherein the first display comprises a first view into the interactive virtual environment from a perspective of the first display device, wherein the perspective of the first display device is defined based on a virtual location and a virtual orientation of the first interaction unit within the interactive virtual environment;
receiving, by the processor, a first video signal from the second video capture device, the first video signal comprising captured video data, from the second perspective, of the interior portion of the first interaction unit and at least a portion of the first display of the interactive virtual environment on the first display device; and
providing, by the processor, a second display signal to a display device of a second interaction unit, the second display signal based on the first video signal and usable to generate a second display of the interactive virtual environment on the display device of the second interaction unit, wherein the second display comprises a second view into the interactive virtual environment, the second view including a portion of the interior portion of the first interaction unit and the at least a portion of the first display from a perspective of the display device of the second interaction unit.

11. The method of claim 10, further comprising:
receiving, by the processor, a second video signal from a video capture device of the second interaction unit, the second video signal comprising video data of an interior of the second interaction unit; and
providing, by the processor, a third display signal to the second display device, the third display signal based on the second video signal and usable to generate a third display of the interactive virtual environment on the second display device, wherein the third display comprises a third view into the interactive virtual environment, the third view including a portion of the environment of the second interaction unit from a perspective of the second display device, wherein the perspective of the second display device is defined based on the virtual location and the virtual orientation of the first interaction unit within the interactive virtual environment.

12. The method of claim 10, wherein the first display signal is based on a third video signal received from a video capture device of a third interaction unit, the third video signal comprising captured video data of the interior portion of the third interaction unit, and the first view includes a portion of the interior portion of the third interaction unit.

13. The method of claim 10, wherein the first interaction unit comprises three or more display devices and three or more video capture devices, wherein:
each given video capture device of the three or more video capture devices is positioned facing at least a portion of a given display device of the three or more display devices and the given video capture device is operable to capture video data of the interior portion of the first interaction unit and the at least a portion of the given display device from a given perspective of the multiple perspectives;
and the method further comprises, providing, by the processor, a given display signal to each given display device of the three or more display devices, the given display signal usable to generate a given display of the interactive virtual environment on the given display device, wherein the given display comprises a given view into the interactive virtual environment from a respective perspective of the given display device, wherein each given view is determined based on the virtual location and virtual orientation of the first interaction unit within the interactive virtual environment.

14. The method of claim 10, wherein:
the first interaction unit further comprises a first audio playback device, and a first audio capture device positioned to capture audio data within the interior portion of the first interaction unit; and
the method further comprises:
providing, by the processor, a first audio signal to the first audio playback device, the first audio signal usable to generate a first audio output associated with the interactive virtual environment by the first audio playback device, wherein the first audio signal includes at least portion of audio data captured by an audio capture device of the second interaction unit; and
providing, by the processor, a second audio signal to an audio playback device of the second interaction unit, the second audio signal usable to generate a second audio output associated with the interactive virtual environment by the audio playback device of the second interaction unit, wherein the second audio signal includes at least a portion of audio data captured by the first audio capture device.

15. The method of claim 14, wherein the output volume level of the first audio playback device associated with the portion of audio data captured by the audio capture device of the second interaction unit is based on a virtual distance between the virtual location of the first interaction unit and a second virtual location of the second interaction unit in the interactive virtual environment.

16. The method of claim 10, wherein the first interaction unit and the second interaction unit are virtually arranged within the interactive virtual environment such that:
the second display device and the second video capture device are virtually disposed along a second side of the first interaction unit; and
the display device of the second interaction unit is disposed along a side of the second interaction unit; and
the method further comprises, virtually positioning, by the processor, the first interaction unit and the second interaction unit adjacent to each other in the interactive virtual environment by positioning the second side of the first interaction unit and the side of the second interaction unit adjacent and substantially parallel to each other in the interactive virtual environment.

17. The method of claim 10, wherein the interactive virtual environment comprises a plurality of virtual interaction units arranged within the interactive virtual environment, the plurality of virtual interaction units including a first plurality of physical interaction units having corresponding physical interaction units capable of receiving one or more users therewithin and at least one phantom interaction unit that does not correspond to any in-use physical interaction unit.

18. The method of claim 11, wherein the first interaction unit is provided using a physical environment unit (PEU) comprising multiple walls and a floor configured to fully surround a user while the user participates in the interactive virtual environment, and the second interaction unit is provided as a physical display unit (PDU) comprising a first side and a second side arranged adjacent and substantially parallel to each other along a common optical axis, the display device and the video capture device of the second interaction unit being disposed along the first side of the PDU; and wherein the method further comprises:
providing, by the processor, a fourth display signal to a second display device of the second interaction unit disposed along the second side of the PDU, the fourth display signal usable to generate a fourth display of the interactive virtual environment on the second display device of the second interaction unit, wherein the fourth display comprises a fourth view into the interactive virtual environment, the fourth view including a portion of the interior portion of the first interaction unit and the generated third display; and
wherein the first display includes video data of the environment of the PDU captured by a second video capture device of the second interaction unit disposed along the second side of the PDU.

19. A system for generating an interactive virtual environment, the system comprising a data storage unit storing processor-executable instructions, a processor in communication with the data storage unit, a first interaction unit, and a second interaction unit, wherein:
the first interaction unit comprises:
a first display device,
a second display device,
a first video capture device positioned facing outwardly at the first interaction unit, the first video capture device operable to capture video data of a surrounding environment of the first interaction unit from a first perspective, and
a second video capture device positioned facing outwardly at the first interaction unit, the second video capture device operable to capture video data of the surrounding environment of the first interaction unit from a second perspective;
the second interaction unit comprises:
a third display device,
a fourth display device,
a third video capture device positioned facing at least a portion of the fourth display device, the third video capture device operable to capture video data of an interior portion of the second interaction unit and the at least a portion of the fourth display device from a third perspective, and
a fourth video capture device positioned facing at least a portion of the third display device, the fourth video capture device operable to capture video data of the interior portion of the second interaction unit and the at least a portion of the third display device from a fourth perspective; and
wherein the processor is configured to:
receive a first video signal from the first video capture device,
provide a first display signal to the third display device, the first display signal based on the first video signal and usable to generate a first display of the interactive virtual environment on the third display device, wherein the first display includes at least a portion of the surrounding environment of the first interaction unit from the first perspective,
receive a second video signal from the second video capture device,
provide a second display signal to the fourth display device, the second display signal based on the second video signal and usable to generate a second display of the interactive virtual environment on the fourth display device, wherein the second display includes at least a portion of the surrounding environment of the first interaction unit from the second perspective,
receive a third video signal from the third video capture device, the third video signal comprising captured video data, from the third perspective, of the interior portion of the second interaction unit and at least a portion of the second display of the interactive virtual environment on the fourth display device, and
receive a fourth video signal from the fourth video capture device, the fourth video signal comprising captured video data, from the fourth perspective, of the interior portion of the second interaction unit and at least a portion of the first display of the interactive virtual environment on the third display device.

20. The system of claim 19, wherein the processor is further configured to:
provide a third display signal to the first display device, the third display signal based on the third video signal and usable to generate a third display of the interactive virtual environment on the first display device, wherein the third display includes at least a portion of the interior portion of the second interaction unit and the second display of the interactive virtual environment on the fourth display device from the third perspective.
